(19) United States
(12) Patent Application Publication
(10) Pub. No.: US 2024/0356312 A1
(43) Pub. Date: Oct. 24, 2024

(54) ELECTRICAL PANELBOARD WITH ARC FAULT PROTECTION AND USER INTERFACE

(71) Applicant: Span.IO, Inc., San Francisco, CA (US)

(72) Inventors: Aleksandar Daniel Oleg Rivin, Boulder, CO (US); Ian Casimir Dimen, Berkeley, CA (US); Cole Hamilton Ashman, San Francisco, CA (US); Nicholas Reid, San Francisco, CA (US); Ryan Carter Kroeze, San Francisco, CA (US); Venkatraghavan Sundararajna, San Francisco, CA (US)

(21) Appl. No.: 18/639,819

(22) Filed: Apr. 18, 2024

Related U.S. Application Data
(63) Continuation-in-part of application No. 18/586,362, filed on Feb. 23, 2024.
(60) Provisional application No. 63/460,774, filed on Apr. 20, 2023.
(60) Provisional application No. 63/583,141, filed on Sep. 15, 2023.
(60) Provisional application No. 63/551,192, filed on Feb. 8, 2024.

(51) Int. Cl. H02B 1/056; H02B 1/21; H02H 1/00; H02H 3/08

(52) U.S. Cl. CPC H02B 1/056; H02B 1/21; H02H 1/0015; H02H 3/083

(57) ABSTRACT

A portion of an electrical panelboard may include an arc fault circuit interruption (AFCI) protection system configured to detect arc fault events occurring in branch circuits and interrupt the flow of electricity in one or more of the branch circuits, where interruption switching devices of the AFCI protection system are electrically coupled between (a) one or more bus bars of the electrical panelboard and (b) branch circuit terminals of the electrical panelboard. The portion of the panelboard may also include an interface panel that enables a user to interact with the AFCI protection system.

### CROSS-REFERENCE TO RELATED APPLICATION(S)

This application claims the benefit of, and priority to, U.S. Provisional Patent Application Ser. No. 63/460,774, “Panelboard Arrangement For Arc Fault Circuit Interruption,” filed on Apr. 20, 2023, which is incorporated herein by reference in its entirety.

This application is also a continuation-in-part of pending U.S. patent application Ser. No. 18/586,362 “Modular Electrical Panelboard,” filed on Feb. 23, 2024, which claims the benefit of and priority to U.S. Provisional Patent Application Ser. No. 63/583,141, “Electrical Panel Construction,” filed on Sep. 15, 2023 and U.S. Provisional Patent Application Ser. No. 63/551,192, “Electrical Panel Construction,” filed on Feb. 8, 2024, each of which incorporated herein by reference in its entirety.

### BACKGROUND

### 1. Technical Field

This disclosure relates generally to arc fault protection and, more particularly, to arc fault protection integrated onto portions (e.g., modules) of electrical panelboards.

### 2. Description of Related Art

An arc fault occurs when a problem in an electrical system results in arcing. Arc faults may be caused by various electrical problems: damaged, overheated, or exposed wiring; stressed, lose or improper devices and connections; pierced insulation or conductors from nails, screws or other sharp objects; deterioration caused by heat, age, stress or abrasion; defective or compromised outlets and circuits; and damaged or unsuitable loads and electrical cords. If left undetected, arc faults can cause further damage to the electrical system, electrical shocks and fires.

As a result, arc fault circuit interruption (AFCI) protection is now required by many building standards. AFCI protection typically comes in the form of a self-contained device that protects an individual branch circuit, such as a residential home miniature breaker. In a common scenario, an electrical panel may be installed first but without any AFCI protection. Individual AFCI breakers are then added to the electrical system to provide protection for specific branch circuits.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a block diagram of an electrical panel with integrated AFCI protection.

FIG. 2A is an end user's view of one implementation of the electrical panel of FIG. 1.

FIG. 2B is a view of the electrical panel of FIG. 2A with the dead front panel removed.

FIG. 2C is a view of the electrical panel of FIG. 2B with the overcurrent circuit breakers removed.

FIGS. 3A-3C are block diagrams of a branch showing different locations for the sensor.

FIG. 4 is a block diagram showing AFCI processing split between in-panel and off-panel.

FIGS. 5A and 5B are diagrams showing possible data sources that may be used for arc fault detection.

FIG. 6 is a block diagram of an AFCI processing system that services multiple branch circuits.

FIG. 7 is a block diagram of an electrical panel with integrated AFCI protection, using sensors and actuators shared among multiple branch circuits.

FIG. 8A is a diagram of a first example branch module with an integrated AFCI protection system.

FIG. 8B illustrates a similar example branch module with an additional column of components over the other bus bar.

FIGS. 9A-9J are diagrams of a second example branch module.

FIGS. 10A-10B are diagrams of a third example branch module.

FIGS. 11A-11E are diagrams of a fourth example branch module.

FIGS. 12A-B are a diagrams of a fifth example branch module.

FIG. 13 is a diagram of a section of a sixth example branch module.

FIGS. 14A-14C are diagrams illustrating front views of an example modular electrical panel.

FIG. 15 is a perspective diagram of the electrical panel with a different arrangement of electrical modules.

FIG. 16 is a perspective diagram of an example enclosure of the electrical panel.

FIG. 17 is a perspective diagram of an example spine of the electrical panel.

FIGS. 18A-B are diagrams of an example mains module.

FIGS. 19A-C are diagrams of an example branch module.

FIGS. 20A-B are diagrams of an example PCM (panel control module).

FIG. 20C is a perspective diagram of an example fan module that fits into the PCM.

FIG. 21 is a perspective diagram of an example gateway module.

FIGS. 22A-D are diagrams of an example lug module.

FIG. 22E is a diagram illustrating example lug module receiving compartments of the spine.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### Arc Fault Circuit Interruption (AFCI) Protection Systems

Aspects of this disclosure relate to electrical panelboards (also “electrical panels,” “panels,” or “panelboards”) with integrated arc fault protection systems. Arc faults can be caused by many different types of problems in the electrical system, which can cause different types of arc faults. For example, arc faults can broadly be classified as parallel arc faults and series arc faults. Parallel arcs occur between two different conductors: hot and neutral, hot and ground, or neutral and ground, for example. Parallel arcs can be caused by shorting between the conductors. Series arcs occur along the same conductor or conductive path. For example, a severed conductor can result in a series arc.

Traditional AFCI breakers are typically self-contained devices that are installed to provide protection for individual branch circuits. However, this approach has many drawbacks. For example, since each AFCI breaker is self-contained, all of the processing and electronics for AFCI protection is replicated in each AFCI breaker, which increases the cost. Moreover, traditional AFCI breakers that are self-contained do not use algorithms or firmware that can be updated or tuned remotely, which results in a less robust and accurate system. In addition, electrical installers typically must stock both traditional circuit breakers, which protect against overcurrent, and AFCI breakers. This results in additional cost and overhead for the installer.

Finally, there are different types of arc faults, and they can be caused by different types of electrical problems. As a result, it can be more difficult to correctly detect arc faults. Self-contained AFCI breakers often have less computing power due to cost constraints and therefore have limited accuracy in detecting arc faults. They may detect an arc fault when no arc fault actually exists. These false positives, also known as nuisance trips, are a nuisance at best and at worst can undermine the end user's confidence in the breaker or electrical installation, requiring rework of the installation.

Accordingly, aspects of this disclosure concern the integration of an AFCI protection system into the electrical panel itself. In one example, an electrical panelboard includes a main terminal that receives a supply of electricity, multiple terminals to supply electricity to branch circuits, and a bus structure that distributes the electricity from the main terminal to the branch circuit terminals. The branch circuit terminals may be conductive stabs, to which traditional overcurrent protection devices, such as residential miniature circuit breakers, are attached. They may also be fuse holders, in panels that use fuses instead of circuit breakers.

In some cases, the AFCI protection system may be fully integrated onto the panelboard, rather than implemented as separate stand-alone devices. The integrated AFCI protection includes current sensors, switching devices (also “relays” or “actuators”) and a processing system. The current sensors sense the flow of electricity through the branch circuits and the switching devices can interrupt this flow of electricity. The processing system analyzes the detected currents for arc faults and controls the switching devices accordingly. The current sensors and switching devices are coupled to conductive paths between the bus structure and the branch circuit terminals. They are positioned on the line-side (upstream) of the branch circuit terminals, rather than implemented as separate breakers that connect to the branch-side (downstream) of the branch circuit terminals.

In other cases, the AFCI protection may be only partially integrated onto the panelboard. For example, some of the current sensors may be located to the branch-side of the electrical panelboard. They may be coupled to downstream sections of the branch circuits or may be built into devices that are plugged into outlets. Similarly, the switching devices may also be located to the branch-side of the electrical panelboard. Some or all of the processing may also take place outside the electrical panel.

This integrated approach has many advantages. Integrating components onto the panelboard allows components to be shared across multiple branch circuits. For example, a single more powerful processor may be used to analyze signals for multiple branch circuits. In addition, the processor may consider data from multiple branch circuits (or even from other panels) to detect arc faults on a specific branch circuit. The processor may also make use of other types of data, such as historical data or information about the electrical characteristics of devices connected to the branch circuit. As another example, a single power supply may be used to power all of the AFCI protection components integrated on the panelboard. In addition, components may also be shared across multiple functions. For example, common components may be used for AFCI protection, energy metering, energy management and other functions implemented on the panel. Sharing components reduces cost.

Another advantage is that AFCI protection may be configured and updated more easily, especially if remote access is provided. An electrical installer may choose to activate AFCI protection where and when needed by individually enabling or disabling the protection function on a per-branch-circuit basis. With remote networked access, the AFCI protection may be reconfigured, updated and monitored without requiring an on-site visit. Specialized apps may also be used. The integrated AFCI protection may also be more convenient to test and inspect than traditional AFCI systems. The integrated approach also allows for the implementation of more advanced and more customized arc fault detection algorithms, which can reduce the number of nuisance trips.

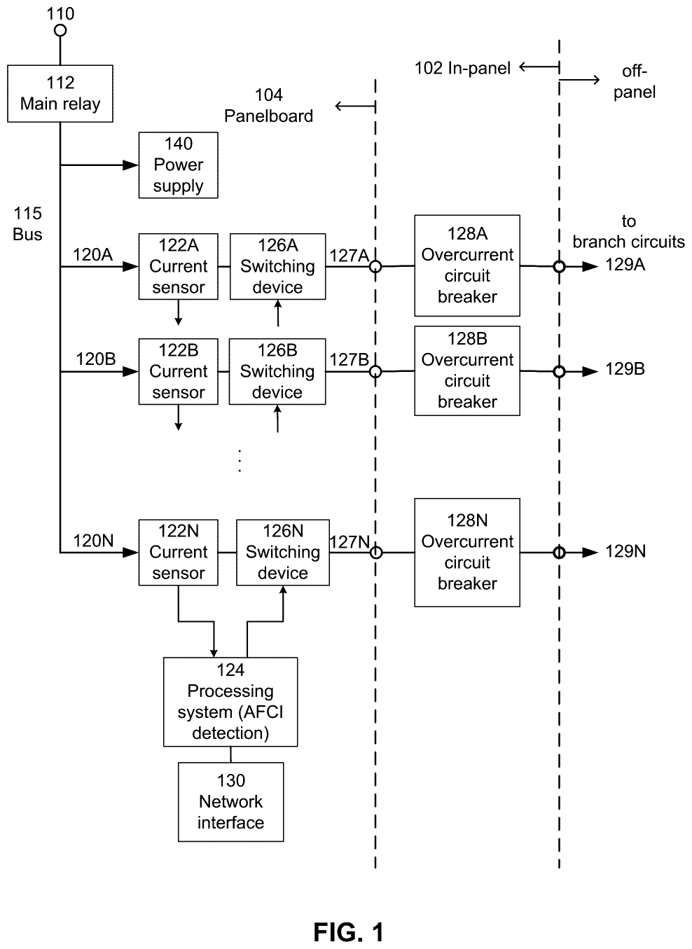

In more detail, FIG. 1 is a block diagram of an electrical panel with integrated AFCI protection. The overall electrical system may be divided into the following regions, as shown in FIG. 1. The electrical panel 102 includes the panel housing and everything inside the housing. Components that are inside the panel housing will be referred to as in-panel components. In-panel components include both components that are part of the panelboard 104 and additional components that an installer might add inside the panel during installation or service, such as traditional overcurrent circuit breakers. The panelboard 104 refers to the structure or backplate that contains the electrical components that are part of the panel. These components may be referred to as native, integrated or on-panelboard components. Components outside the panel are referred to as off-panel components.

The panelboard 104 shown in FIG. 1 includes a main terminal 110 and many branch circuit terminals 127A-N. The main terminal 110 receives a supply of electricity, although electricity may be received through other terminals in some designs and there may even be no main terminal. Main relay 112 allows for interruption of that supply. A bus structure 115 distributes the electricity from the main terminal 110 to the branch circuit terminals 127A. The bus structure 115 may use conductive bus bars.

Each branch 120A-N from the main bus structure 115 to the branch circuit terminals 127A-N includes native AFCI circuitry, which includes a current sensor 122 and switching device 126 in this example. The current sensors 122 are coupled to the conductors that branch off the bus 115 and they sense the current flowing through the branches 120. Examples of current sensors include current transformers, Hall effect sensors, current sensors based on magnetoresistive elements, inductive pickup coils, shunt resistors, and fluxgate current sensors. Depending on the design, the current sensor 122 may be connected in series along the branch 120, or it may be coupled in some other way to the branch (e.g., inductive coupling). It may be an impedance in series with the current flow, for example by sensing across a simple wire with no added resistance. Other types of sensors, for example voltage sensors, may also be used. The switching devices 126 are electrically connected along the branch conductors 120 and can be switched to interrupt the flow of electricity in the branch circuits 129. Examples of switching devices include semiconductor switches, relays, motor-driven switches, and shunt trip circuit breakers or other electrically triggered spring-driven contact systems. The switching and sensing may be done by low voltage circuitry in the panel.

The panelboard 104 in this example also includes a native processing system 124, which may include analog-to-digital converters, microcontrollers, and output drivers. The processing system 124 is shared by multiple branches 120, which reduces the cost compared to an architecture where a separate processing system is provided for each branch. For example, a single processing chip may be used for all of the branches in the panel. Alternatively, the processing system may include multiple processing chips, and each chip is used for a subset of the branches in the panel. The processing system 124 analyzes the current signals from the current sensors 122, detects arc fault events based on the analysis, and controls the switching devices 126 to interrupt the flow of electricity to the branch circuits in response to detecting arc fault events. The processing system 124 may include digital integrated circuits, FPGAs, ASICs, DSPs, mixed signal integrated circuits, processors and/or controllers. In some cases, the processing system 124 may be software programmable and the overall AFCI protection may be software configurable.

The panelboard 104 also includes a network interface or gateway 130 to provide connectivity to compute resources outside the panel. The interface 130 may be wireless and/or wired. It may be for local connection, such as Bluetooth or connection to handheld diagnostic tools, or for broader network connection, such as to the Internet or a local area network. The network interface 130 may be used to allow the processing system 124 to access compute resources and data from outside the panel. It also allows the processing system 124 to provide data and status reports/alarms to other devices, such as a phone-based app or a central control center for a residence. In some cases, the AFCI functionality of the processing system 124 may be modified, updated and/or configured remotely via the network interface 130.

The panelboard 104 also includes an integrated power supply 140 to power the on-panelboard components, such as the switching devices 126, processing system 124, network interface 130 and possibly the current sensors 124 (if they require power). The power supply 140 draws power from the electricity supplied through the main terminal 110 and conditions it for the on-panelboard components. It may draw directly from the main terminal 110, from bus 115, or from stabs, for example. For clarity, the power feeds from the supply 140 to the different components are not shown in the figures.

In this example, the branch circuit terminals 127 are conductive stabs, to which overcurrent circuit breakers 128 may be attached. These circuit breakers 128 may be installed and removed in the field by a trained installer. The installer also connects the circuit breakers 128 to the branch circuits 129, which distribute the electricity to appliances and other loads throughout the premises.

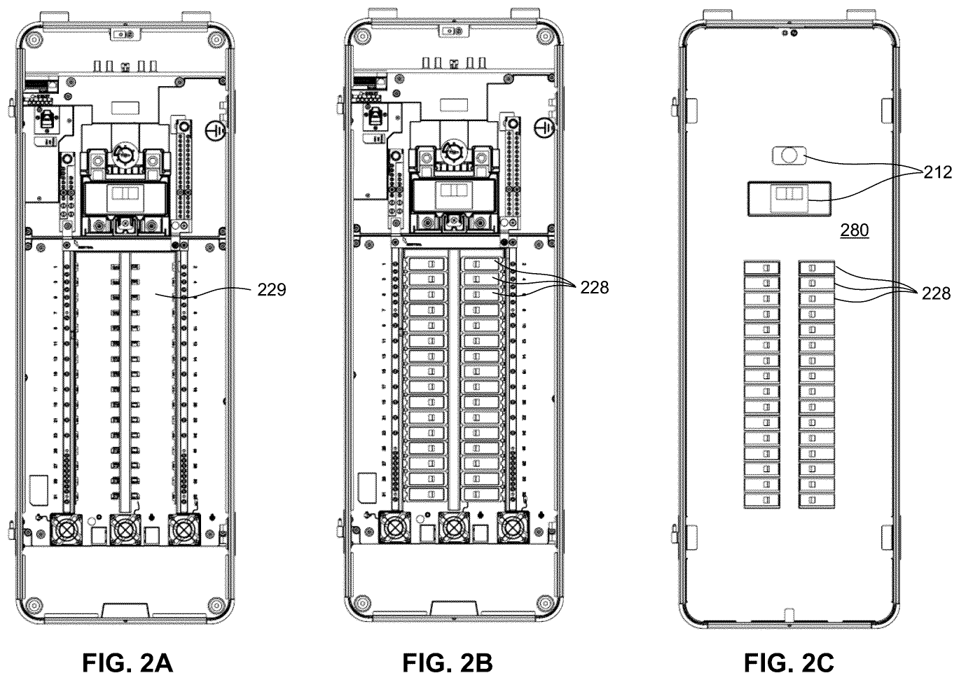

FIGS. 2A-2C show front view of one physical implementation of the panel of FIG. 1. FIG. 2A is an end user's view of the panel. In the end user view, most of the electrical components are not physically accessible, except for the following. Traditional overcurrent circuit breakers 228 may be set and reset by the end user, as can the main relay and breaker 212. The AFCI components may also have some user-accessible features, such as test and reset (not shown in FIG. 2). The rest of the electrical components in the panel are hidden under a dead front panel 280. Access may also be possible through the network interface. For example, an app may provide a user interface to the electrical components that are not physically accessible.

FIG. 2B is a view of the electrical panel of FIG. 2A with the dead front panel removed. The circuit breakers 228 are still installed. FIG. 2C is a view of the electrical panel of FIG. 2B with the overcurrent circuit breakers removed. The on-panel components shown in FIG. 1 may be implemented in various locations in FIGS. 2B and 2C. The current sensors 122 and switching devices 126 may be implemented underneath the panel 229 for the circuit breakers 228. The power supply 140, processing system 124 and network interface 130 may be implemented on the panelboard away from the main electrical distribution area.

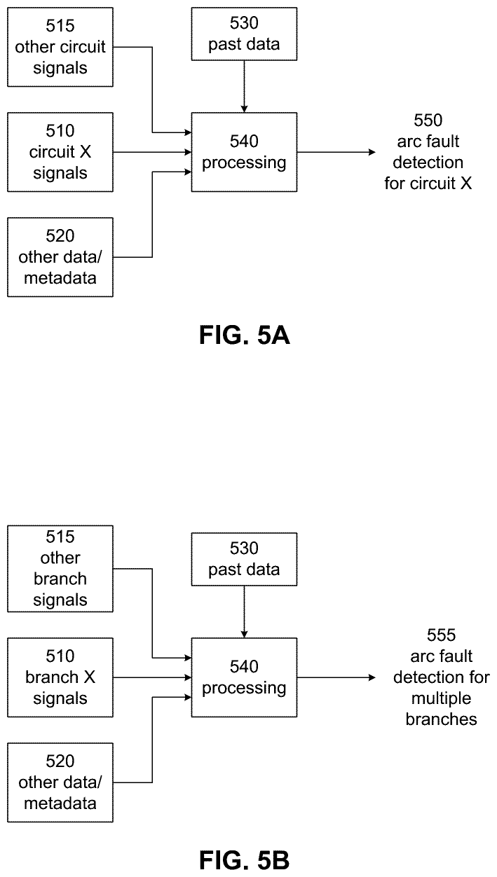

FIGS. 1 and 2 show one example of an electrical panel. Other variations will be apparent. For example, electrical panels may also receive and provide DC power. There may also be power distribution between the AC and DC parts of the electrical panel. Examples of other electrical panels in which AFCI protection may be implemented are described in U.S. Pat. No. 11,342,754 FIGS. 5-16 and the associated text, which are incorporated by reference in their entirety. AFCI protection generally includes the following functions: monitoring (by current sensor 122 and/or other sensors), analysis/detection (by processing system 124) and interruption (by switching device 126 or other actuators). However, not all of these have to be on the panelboard.

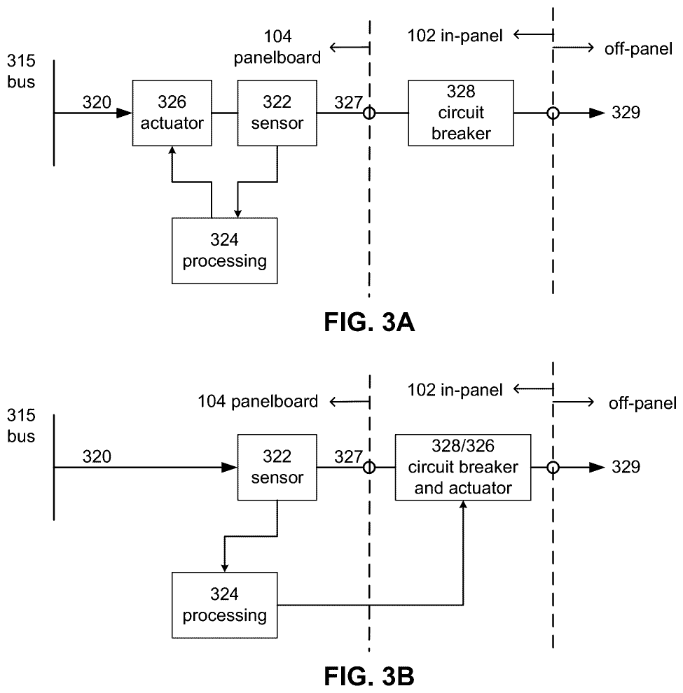

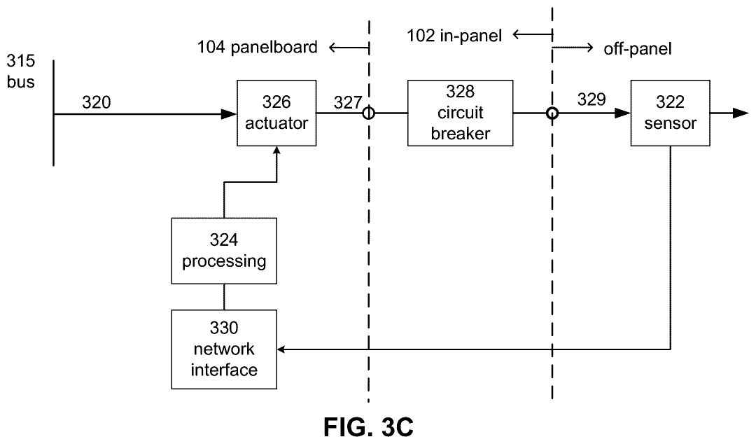

FIGS. 3A-3C show some examples of alternate locations for the sensor 322 and actuator 326. These figures show one branch 320 from bus 315. In FIG. 3A, the order of the sensor 322 and actuator 326 are reversed, but both are still on the panelboard.

In FIG. 3B, the actuator 326 may be part of a circuit breaker that is installed in the panel but is not native to the panelboard. For example, the actuator 326 may be integrated with an overcurrent circuit breaker 328. The processing system 324 may control the actuator 326 via in-panel communications, for example if the devices 328/326 and 324 have a standard signaling interface.

In FIG. 3C, the sensor 322 is outside the panel. It may be located anywhere along the branch circuit 329. It may be integrated into devices that are plugged into outlets or may be integrated into outlets. Current sensing may also be added to monitor electricity flow through branch circuit conductors. In this example, the current signals are communicated to the processing system 324 via the network interface 330.

FIGS. 3A-3C show some examples. The sensor 322 and/or actuator 326 may also be located at other positions, including both in-panel and off-panel. For example, many devices already have integrated actuators. Overcurrent circuit breakers, certain types of outlets, and many appliances include actuators. These actuators may be used to provide AFCI protection if the processing system 324 can access and control the actuator via some interface.

In most embodiments, the panelboard will include at least one of the sensor 322 and the actuator 326 (but not necessarily both). It often will also contain processing capability for the most basic, required AFCI protection.

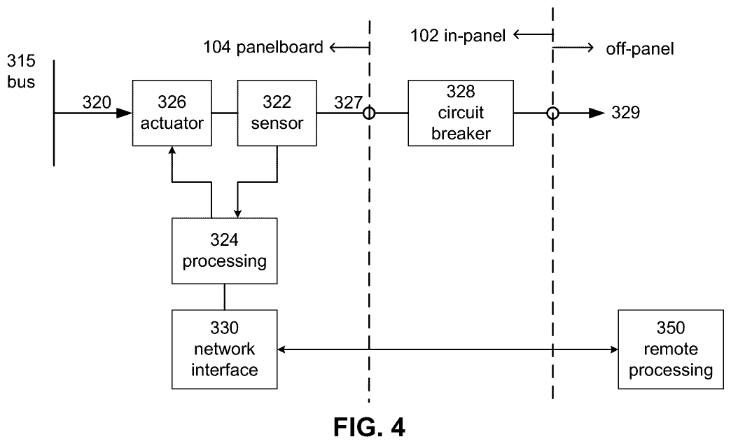

Finally, the processing capability may also be located at or split between different locations. FIG. 4 is a block diagram showing AFCI processing split between in-panel processing 324 and off-panel processing 350. Some processing 324 is better implemented as native to the panelboard. For example, safety standards may require certain functions to be contained entirely within the electrical panel. In addition, it may be advantageous to implement certain functions within the electrical panel even if not required to do so, for example if fast response time is required, if the processing is local to the panel, or if availability is required even when there is no network connection. When safety is involved, it is not unusual to require that some basic safety function is always available and operating under all circumstances. Those functions are usually better implemented on the panelboard.

Remote processing 350 may be appropriate for functions where real-time operation or low latency are not required, where the processing is not just local to the panel, where significant compute resources are required, or where the additional functionality is optional or augments a more basic function that is in-panel.

FIGS. 5A and 5B are diagrams showing possible data sources that may be used for arc fault detection. FIG. 5A shows possible data sources used for arc fault detection on branch circuit X. The data sources may include real-time measurements 510 of branch circuit X, real-time measurements 515 of other branch circuits, other types of data/metadata 520, and past data 530. The past data 530 may be used directly, or it may be used to adapt the processing 540 used to detect arc faults. In FIG. 5A, some or all of this data is used to detect arc faults 550 for branch circuit X alone. In FIG. 5B, the arc fault detection 555 for multiple branches are considered together. For example, a likelihood of arc fault may be calculated for each branch and then the branch with the highest likelihood is identified as the one with the arc fault.

In more detail, basic arc fault detection capabilities may be required to detect a limited set of lab-generated arc fault scenarios, with a small set of acceptance criteria. The approaches for basic arc fault detection for a branch circuit may be based on a frequency domain analysis of the current signals for that branch circuit and/or a time domain analysis of the current signals. This basic functionality is likely implemented on the panelboard, particularly if required by safety standards.

However, having a more powerful native processor allows for more sophisticated processing. Different types of arc faults may have different characteristics. Arc faults may broadly be classified as parallel arc faults and series arc faults. Parallel arc faults may manifest as large, uncontrolled currents which pass through a fault path. In some approaches, parallel arc faults may be detected by counting the number of times that current exceeds a threshold within a given time period. Parallel arc faults may also be detected by looking for the current to cease for some fraction of the AC line cycle, which may indicate the extinction and re-ignition of the arc as current flow ceases during the AC line cycle reversal and then is re-established.

Series arc faults may manifest as irregular, rapidly varying voltage drops which act to reduce load current. These faults may produce signal variation across a broad range of frequencies due to the stochastic nature of arc conduction, and so may be detected by monitoring the amplitude of the current signal in one or more high frequency bands, such as bands starting at no less than 20-30 kHz and in some cases extending up to 20 MHz or more. Detection may also be based on correlating these high frequency signals with the phase of the AC line cycle.

Different detection techniques for different arc faults may be loaded onto the processing system and applied as appropriate to different branches. The techniques used may be updated as they are improved or enhanced.

The detection techniques may also be adapted to the specifics of the branch circuit. For example, the risk of various arc faults occurring may depend on the loading of the branch circuit. Different appliances may have different risk of arc fault or specific signatures characterizing arc faults that may occur in that appliance. The detection techniques applied to the current signals from a particular branch circuit may be tailored to the appliances loaded on that branch circuit. As another example, arc fault detection may be adapted based on past data for the branch circuit. A particular branch circuit may be subject to certain background signals, noise or crosstalk. Measurements of these may be collected over time and then used as a baseline against which arc fault detection is performed. As a final example, adaptation may be used to reduce the rate of false positives. When false positives (nuisance trips) occur and are identified as such, this information may be collected over time and the detection techniques are then adapted to better distinguish between real arc faults and false positives, or to determine whether a detected fault is actually a false positive. Of course, actual detected arc faults may also be stored, characterized, and used to improve detection.

The information used to adapt the detection techniques may be based on measurements of the branch circuit and/or data that is provided otherwise. For example, the panel may automatically discover what appliances are loading which branch circuit. Alternatively, some other device may discover this information and transmit it to the panel. In yet another alternative, an installer or electrician may specify this information, for example via the user interface on an app. Analogously, baseline noise and crosstalk measurements may be performed by the panel itself, or by other devices and then provided to the panel.

The analysis for adaptation may also be performed in-panel (e.g., by the AFCI processing system) or off-panel (e.g., by Internet compute resources). Off-panel resources may provide more computing power to execute more complex analysis, particularly if the analysis is not required to be real-time. Off-panel resources may analyze large, stored records of past measurements and events, including across multiple branch circuits, across different panels, or even across different premises.

In some cases, off-panel resources may be limited to providing a veto function on in-panel fault detection, rather than providing off-panel fault detection. This way, safety is not jeopardized if the off-panel resource is not available. The in-panel resource may detect faults based on a simpler but less accurate algorithm, and the off-panel resource then performs a more elaborate, more accurate analysis of the data. If the off-panel resource determines that the detected fault is a false positive, it may override the simple in-panel algorithm. However, if the off-panel resource is not available or does not complete in time, this does not jeopardize safety.

In yet another variation, the arc fault detection techniques may consider more than one branch circuit. Rather than analyzing the signals from only one branch circuit to detect arc faults on that branch circuit, the signals from other branch circuits may also be analyzed. For example, if there is cross-talk between branch circuits, then an arc fault on one branch circuit may result in current anomalies on the other branch circuits even though there is no arc fault on those circuits. Detection of arc faults in situations such as this may be improved by considering cross-correlation of signals on different branches, or by considering which of the branches is the most likely location of the arc fault.

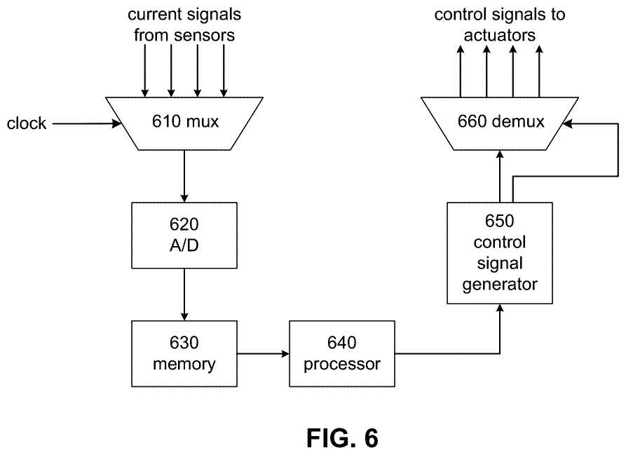

In other designs, the various components 122, 124, 126 for the AFCI protection system of FIG. 1 may be shared in different ways between the different branch circuits. In FIG. 1, there is one current sensor 122 and one switching device 126 for each branch circuit 129, and one processing system 124 is shared by all of the branch circuits. FIG. 6 is a block diagram of such a processing system. The current signals from the sensors are multiplexed 610 to analog/mixed signal circuitry 620, which operates at a higher clock frequency than the sampling frequency of the current signals. The circuitry 620 samples each of the signals from the current sensors and saves the samples to memory 630. The circuitry 620 may also perform some conditioning or pre-processing, such as noise filtering. A microprocessor 640 analyzes the samples for possible arc faults. When an arc fault is detected, the processor instructs circuitry 650 to send a control signal to the appropriate actuator, which is selected via a demultiplexer 660. The multiplexing 610 and demultiplexing 620 functions may be provided by components other than separate multiplexers and demultiplexers.

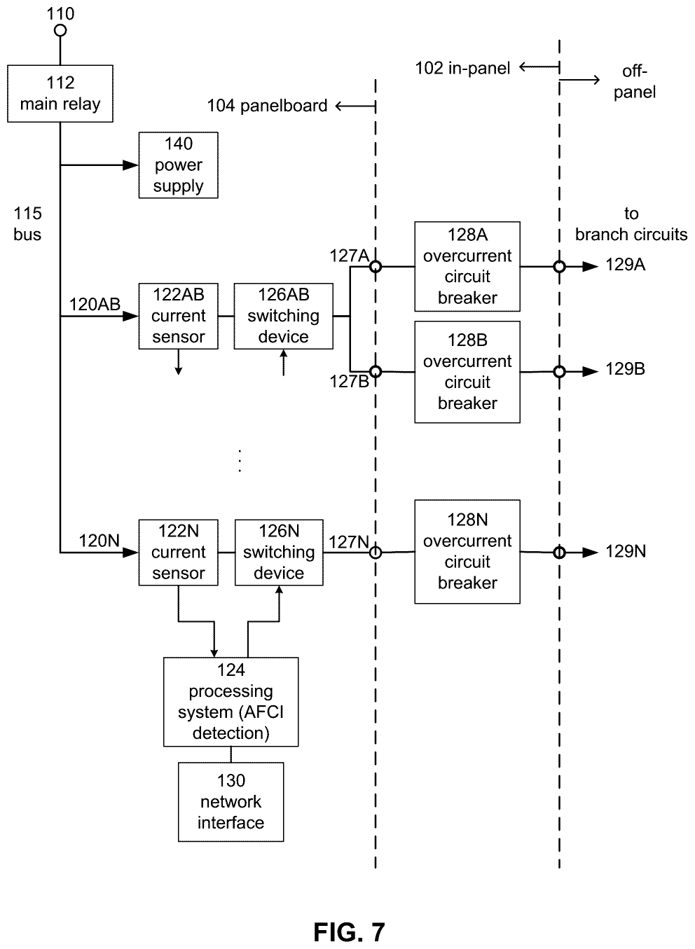

FIG. 7 shows a variation in which the current sensor 122 and switching devices 126 are shared among different branch circuits 129. FIG. 7 is the same as FIG. 1, except that there is only one branch 120AB from bus structure 115, one current sensor 122AB and one switching device 126AB for the two branch circuits 129A and 129B. In other variations, only the current sensor may be shared, or only the switching device may be shared.

One advantage of the AFCI architectures described herein is that the AFCI protection is more easily configurable. The AFCI protection may be software configurable, both in terms of which branch circuits are protected and also in terms of what detection/protection is applied to each branch. In some cases, AFCI protection may be provided for all branch circuits. If the main relay is also controllable by the processing system, then there may also be redundancy. If an arc fault is detected on a branch circuit but the actuator for that branch circuit is not working, the processing system may interrupt the supply of electricity at the main relay. In some cases, the main relay may serve as the primary actuator, so that the main relay is opened whenever an arc fault is detected on any branch circuit.

The components used for AFCI protection may also be used to provide other functions or additional functions. For example, the panel may send notices whenever an arc fault is detected. Other types of messages, such as diagnostic messages or monitoring messages, may also be transmitted. These messages may be displayed on the panel or may activate indicators on the panel, such as LEDs. They may also be sent off-panel, for example to user devices or apps, or to other panels or other components of the electrical distribution system.

The processing system 124 may be programmed to also detect overcurrent situations. This may be used to augment the physical overcurrent circuit breakers or possibly to replace them. As additional examples, the components shown in FIG. 1 may be used to provide energy metering—monitoring the usage of electricity on different branch circuits. Energy management—controlling the usage of electricity on different branch circuits—may also be implemented. This provides additional functionality by reusing already existing components. The reverse is also true. If these components already exist in order to provide other functions such as energy metering or management, they may be reused to also provide AFCI protection.

The following paragraphs provide structural descriptions of portions of electrical panelboards with integrated AFCI protection systems. In the following examples, the portions are branch modules (however this is not required). A branch module is a modular electrical component of an electrical panelboard that couples electricity from a bus structure (e.g., one or more bus bars) to one or more branch circuits.

### First Example Branch Module

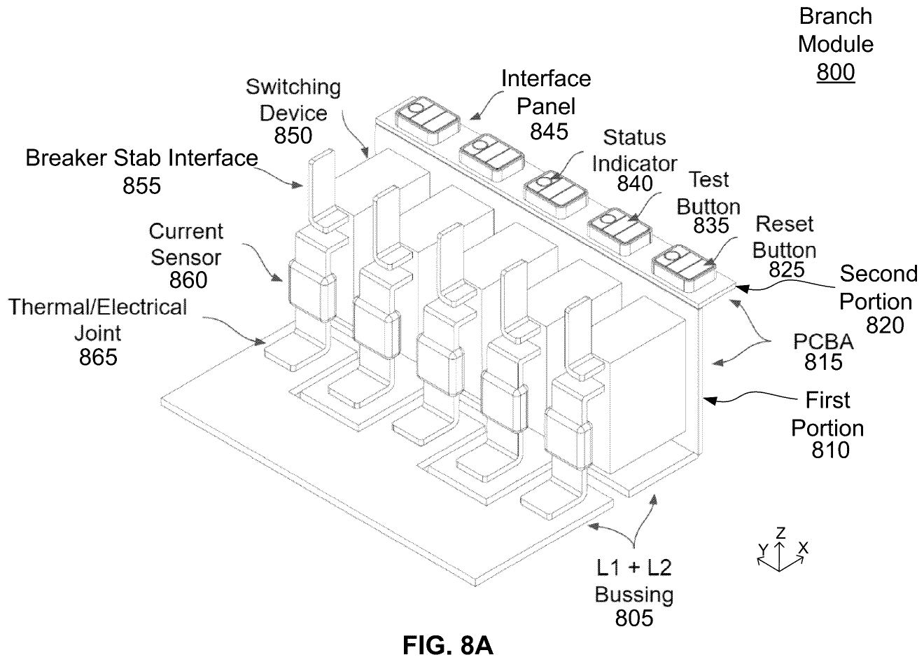

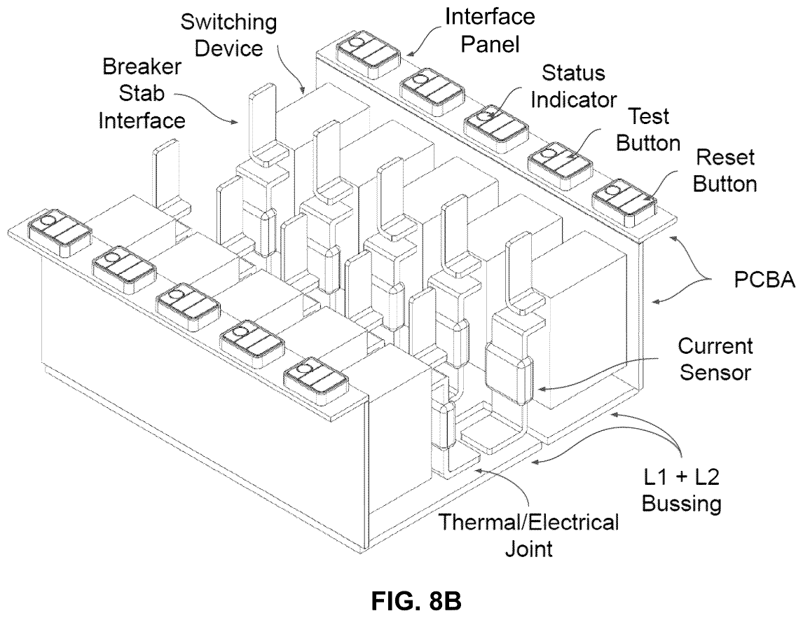

FIG. 8A is a diagram of a first example branch module 800 with an integrated AFCI protection system. The first branch module 800 includes two electrical busses 805 (“L1 busbar” and “L2 busbar”) interlaced (but unconnected electrically within the branch module 800), thermal/electrical joints (“joints”) 865, current sensors 860 (e.g., 122, 322), switching devices 850 (e.g., 126, 326), circuit breaker stab interfaces 855 (e.g., 127), a printed circuit board (PCBA) 815 (e.g., part of processing system 124, 324), and an interface panel 845. As illustrated, a joint electrically couples one of the busses to a switching device. The joint includes a current sensor (or a voltage sensor) around a middle portion of the joint. A breaker stab interface extends from the switching device and protrudes upwards. Example current sensors include a current shunt and a current transformer. Other example current sensors include inductive sensors.

In FIG. 8A, a joint is a flat piece of conductive material (e.g., metal) bent into an “S” shape (also referred to as an S shaped bracket). A joint includes a first tab portion directly coupled to a bus bar, a middle portion that extends upward (+z direction), and a second tab portion bent towards a side of a relay (e.g., in the x direction). A stab interface extends from a same side of the relay (−x direction) and is bent upward (z direction). That side of the relay may be referred to as an interior side. In other embodiments, the stab interface may extend from a different side of the relay. The distance between stab interfaces (“pitch”) may be substantially an inch (e.g., ±10%) or greater to allow circuit breakers to couple to the stab interfaces.

The relays have rectangular prism shapes and are arranged in a column along the y axis above one of the bus bars. In the example of FIG. 8A, the column is not above the interlaced portions of the bus bars (as viewed along the z axis). The shortest edges of the relays are substantially aligned with the y axis (e.g., within 5 degrees). To create uniformity and compactness. Similar to the stab interfaces, the pitch between the relays may be substantially an inch or greater. In the example of FIG. 8A, the switching devices are in series, intended to interrupt current and voltage to a circuit when an AFCI fault condition is triggered.

Among other things, the PCBA is configured to receive current sensor signals and control relays based on the signals. The PCBA includes a first portion 810 and a second portion 820 that are substantially perpendicular (e.g., within 5 degrees) to each other. The first portion of the PCBA is a panel on its side, such that the panel surface faces the switching devices (specifically, the panel surface faces sides of the switching devices that are opposite to the sides that are coupled to the joints). Said differently, an edge of the first portion is aligned (along the z axis) such that the plane of the first portion is substantially perpendicular (e.g., within 5 degrees) to the plane of the bus bars (compared to being substantially parallel (e.g., within 5 degrees) to the plane of the bus bars). In the y direction, the PCBA panel extends along the column of switching devices. Among other advantages, this branch module 800 allows the PCBA to be closer to the switching devices, which makes the first branch module 800 more compact along the x direction. Increased compactness in the x direction may make the branch module 800 easier to install. Additionally, due to the PCBA being so close, the switching devices and/or the current sensors can be hard connected to the PCBA (e.g., a blind mate connection) (the hard connections are not illustrated in FIG. 8). Hard connections eliminate the need for a wiring harness, making the branch modules less complex and potentially easier to assemble (e.g., on a manufacturing line). In some embodiments, the PCBA can receive signals from one or more current sensors and control one or more corresponding switching devices based on the current sensor signals. Among other advantages, a single PCBA for controlling two or more relays reduces processor redundancy and allows for more advanced AFCI functionality (compared to a separate PCBA for each relay).

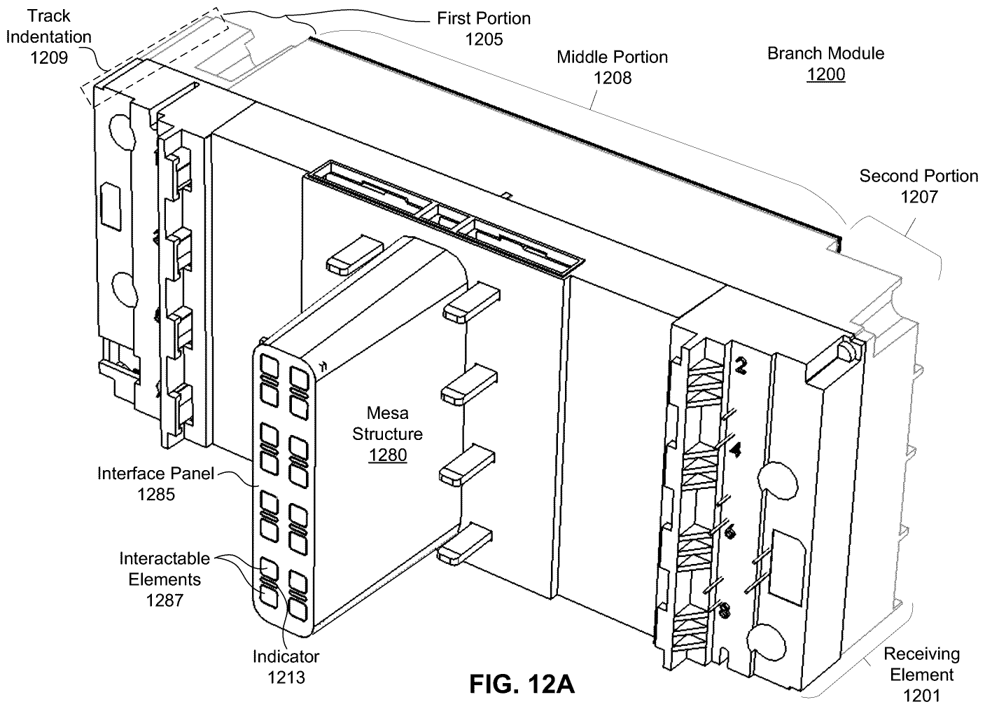

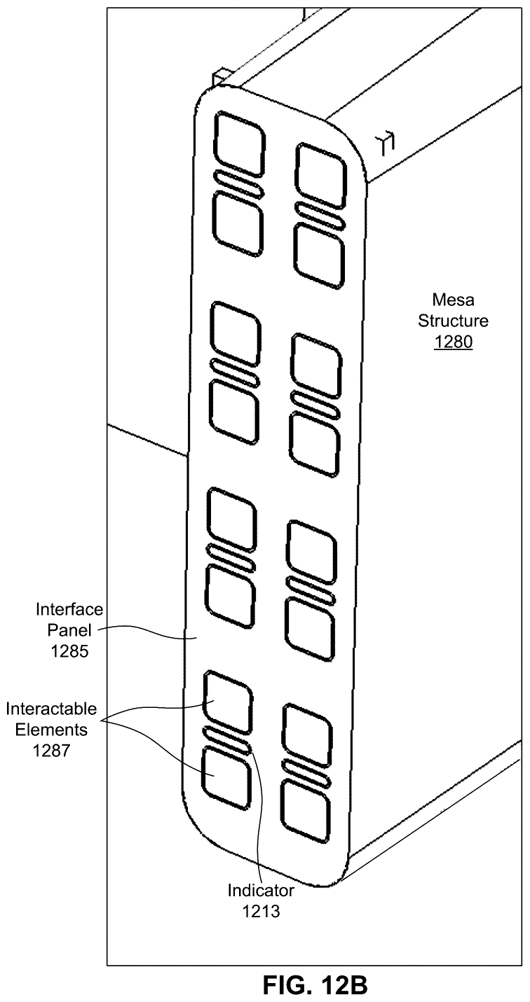

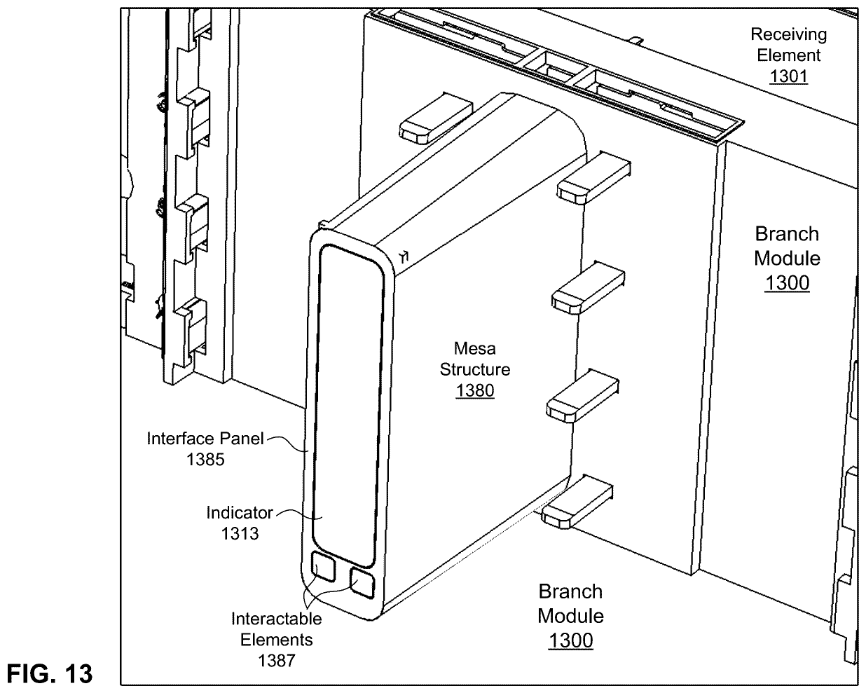

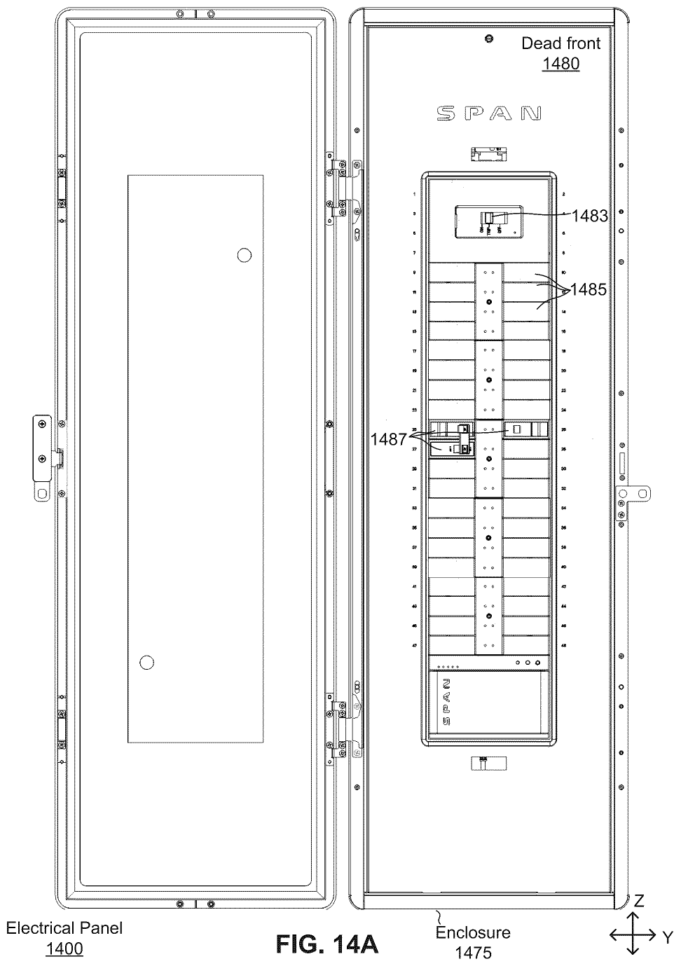

The interface panel allows a user (e.g., a homeowner or technician) to interact with the AFCI protection system of the branch module 800. The interface panel includes five components that are each hard connected to the second portion of the PCBA. The AFCI components have interface surfaces facing upward (the +z direction). In the example of FIG. 8A, there is an AFCI interface component for each switching device, however there may be more or less interface components per switching device (e.g., a single AFCI interface component for all switching devices). The AFCI interface components each include buttons (examples of interactable elements) and a status indicator 840. The buttons include a test button 835 and a reset button 825. However, an AFCI interface component may include additional or fewer interactable elements (e.g., buttons). For example, an AFCI interface component may include a single interactable element (e.g., button) that performs both test and reset functionalities. Status indicators, test interactable elements (e.g., buttons), and reset interactable elements (e.g., buttons) are further described with respect to FIGS. 12 and 13 and in the section titled “Additional Examples of Panelboards with AFCI Protection.”

A current sensor senses the current of the joint. In FIG. 8A, the current sensors are outside of the switching devices. This may improve heat dissipation. However, in some embodiments, a current sensor can be within a switching device.

In the example of FIG. 8A, the branch module 800 includes a single column of components (e.g., joints, switches, stabs, and AFCI interfaces) primarily over one of the bus bars. FIG. 8B illustrates a similar example branch module with an additional column of components over the other bus bar. The assembly of components in the additional row may be symmetrically arranged relative to the first column of components. The additional column may increase the number of branch circuits the branch module can support.

### Second Example Branch Module

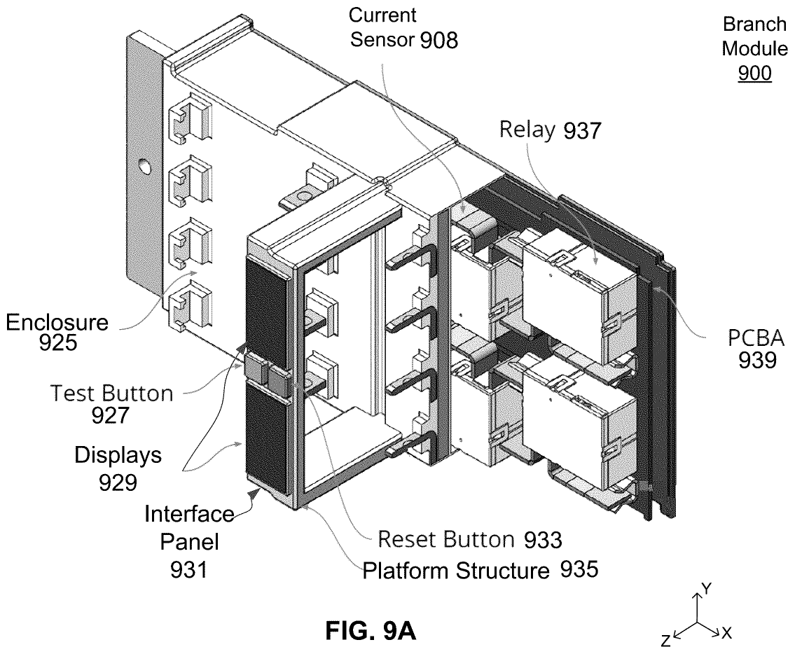

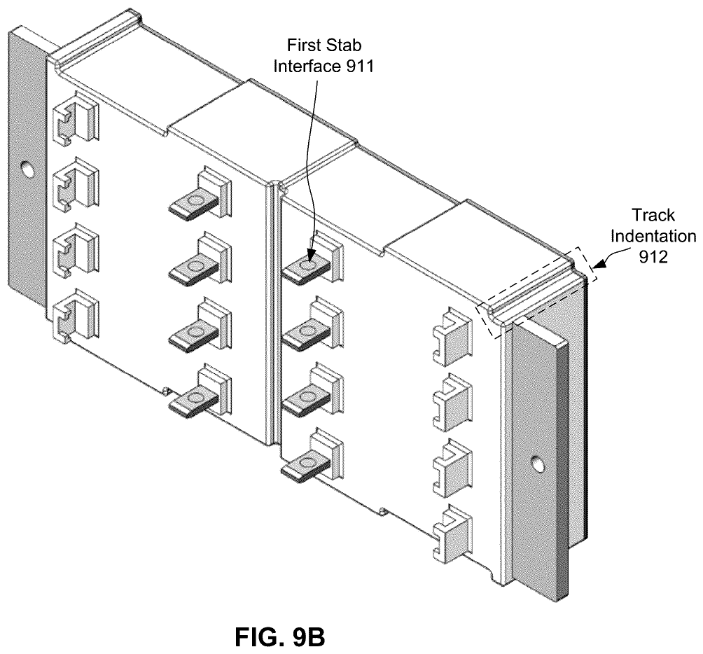

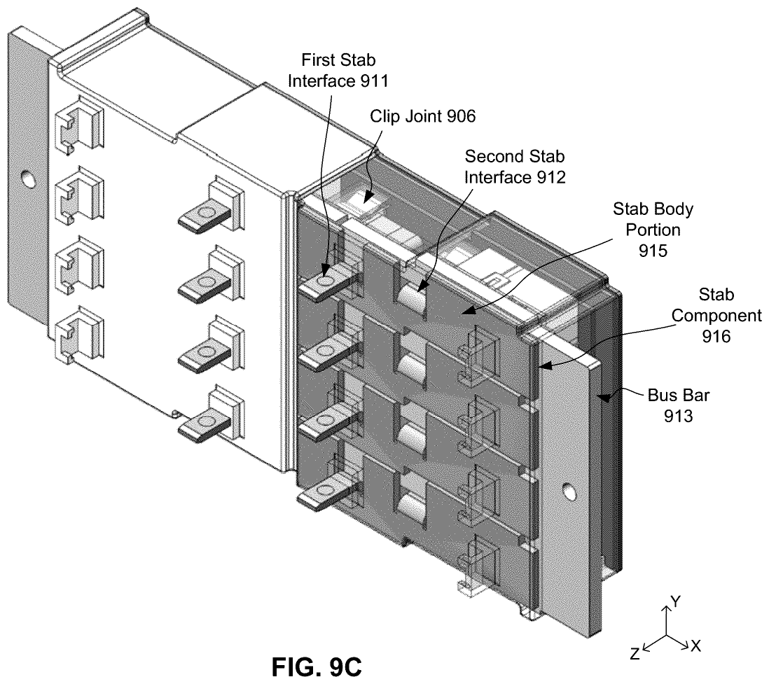

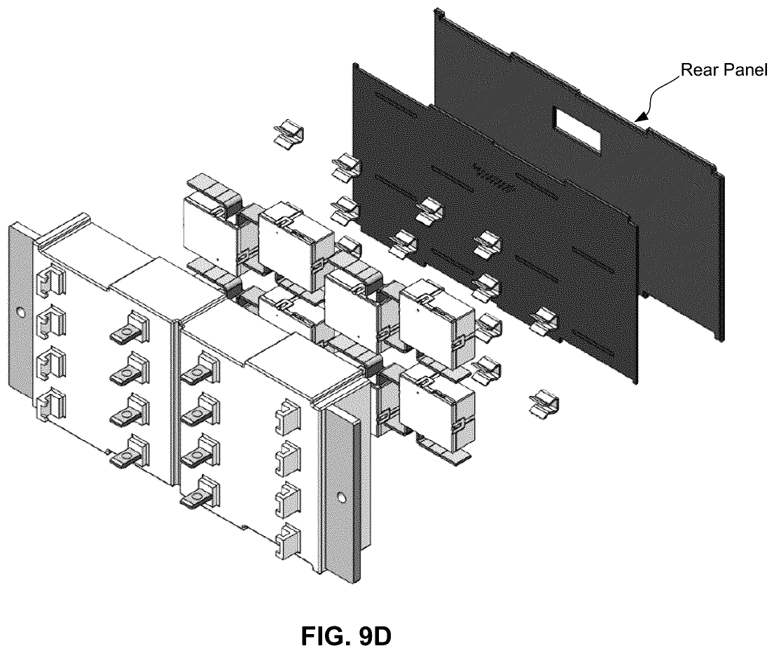

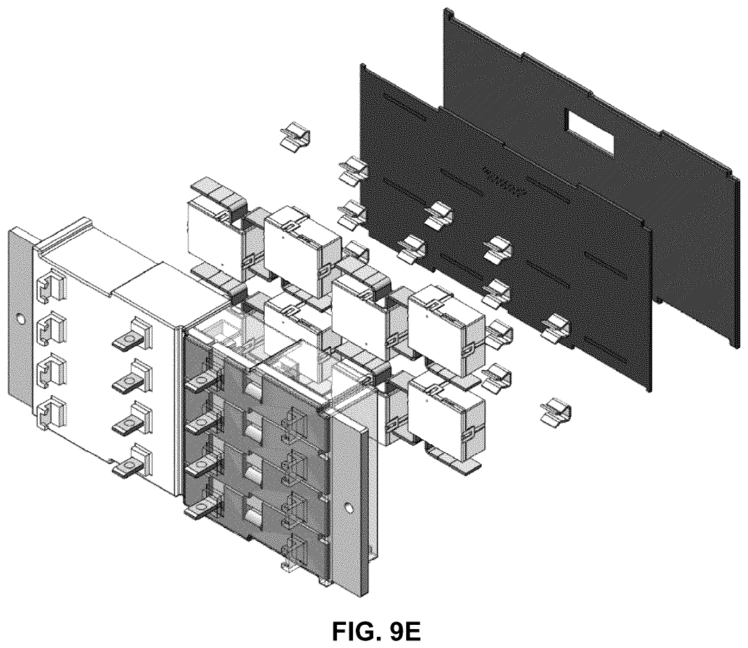

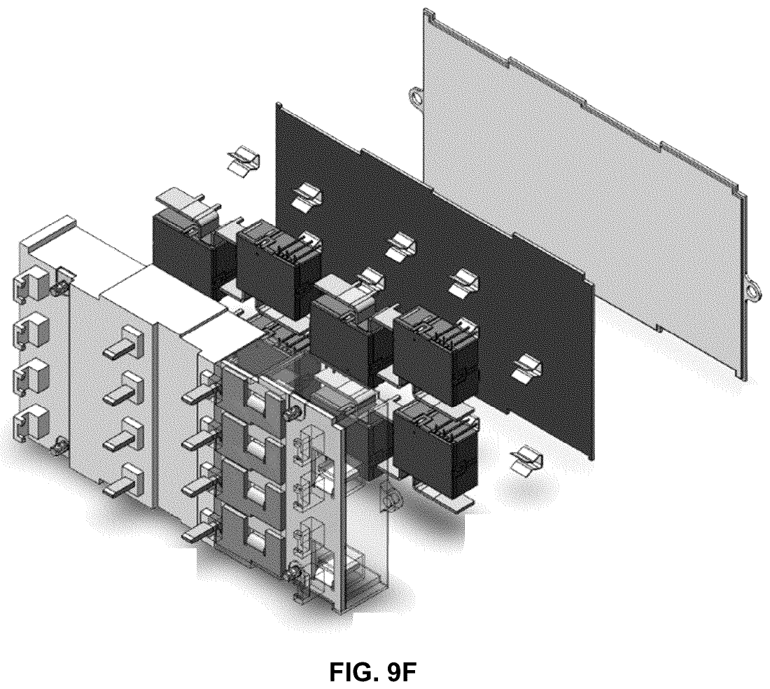

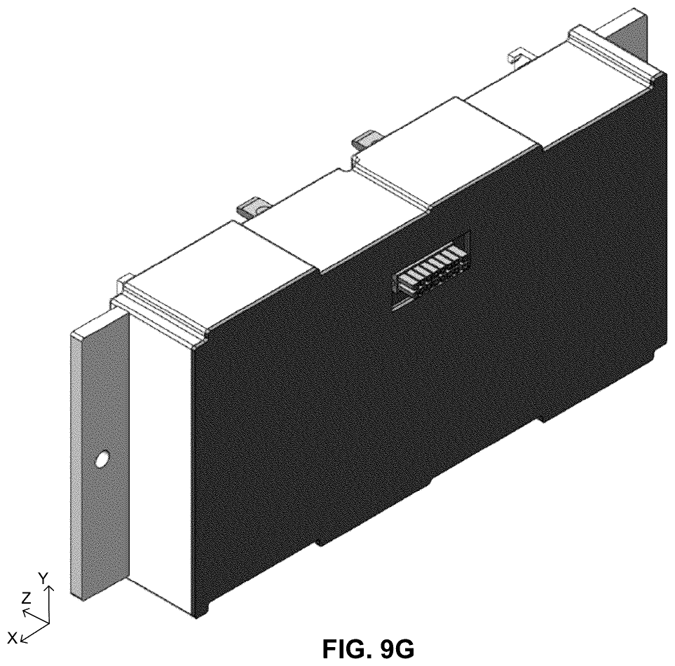

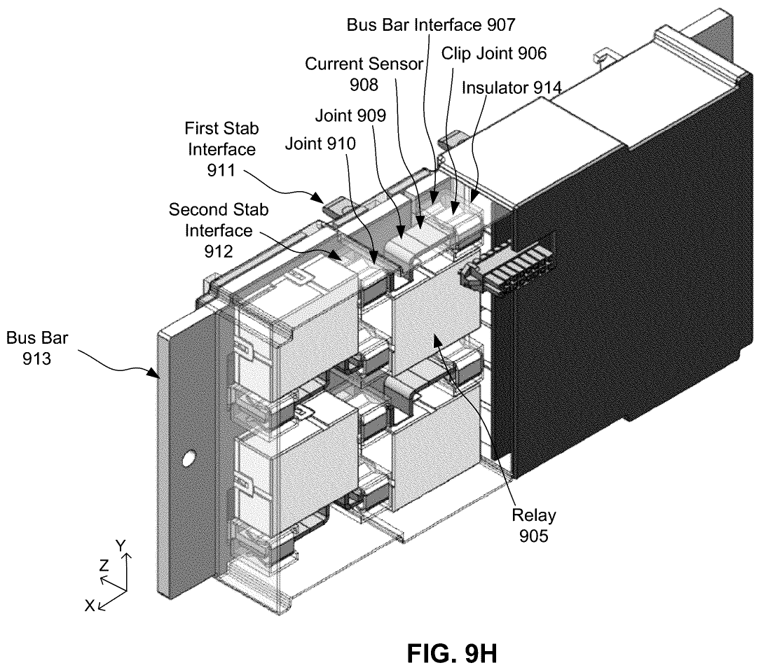

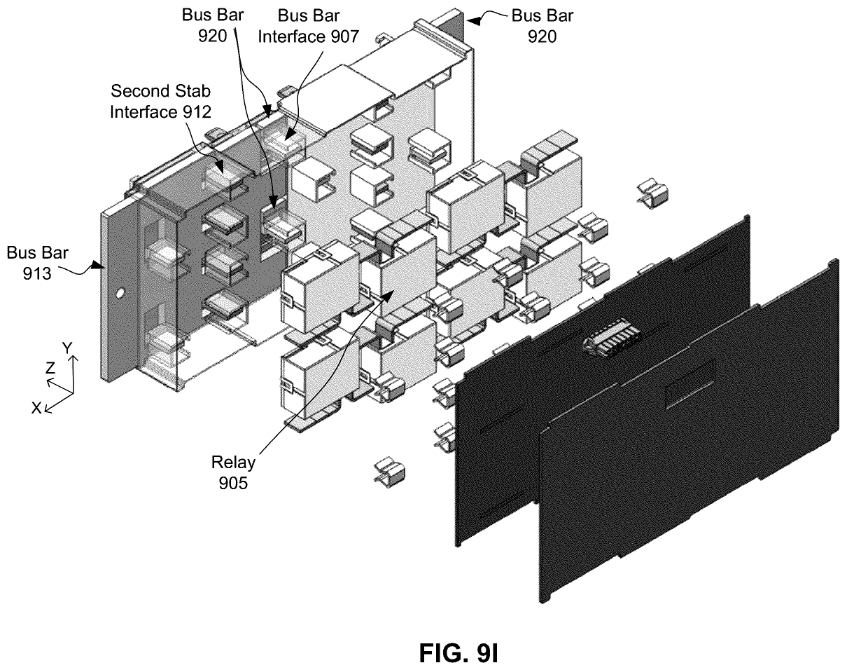

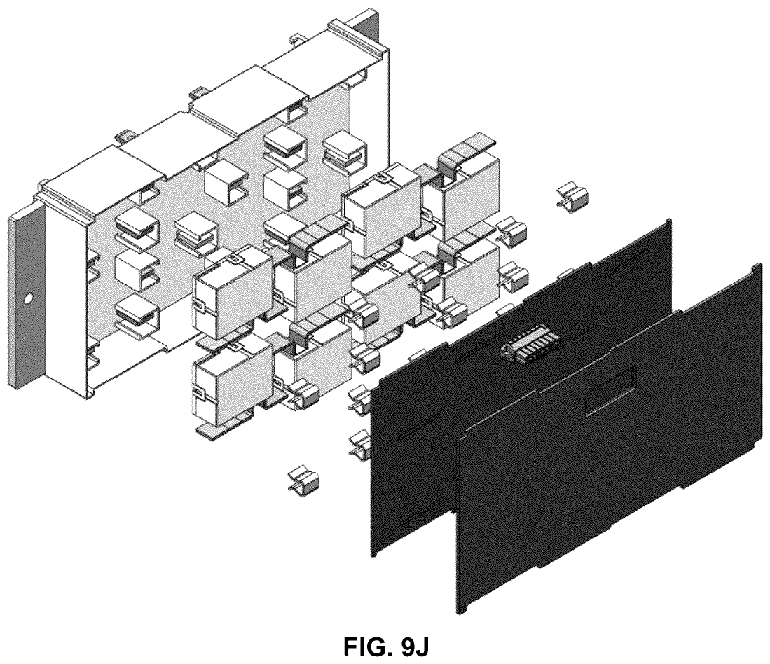

FIGS. 9A-9J (“FIG. 9” collectively) are diagrams of a second example branch module 900. Among other advantages, the arrangement of components in the second branch module 900 forms a compact AFCI assembly.

FIG. 9A is a cross-sectional view of the second branch module 900. Specifically, part of the enclosure 925 (e.g., an injection mold or overmold enclosure), part of a bus bar, and parts of the stab interfaces are removed to expose components, such as the current sensors (including 908), relays (including 937 and 905), and PCBA 939 (e.g., part of processing system 124, 324).

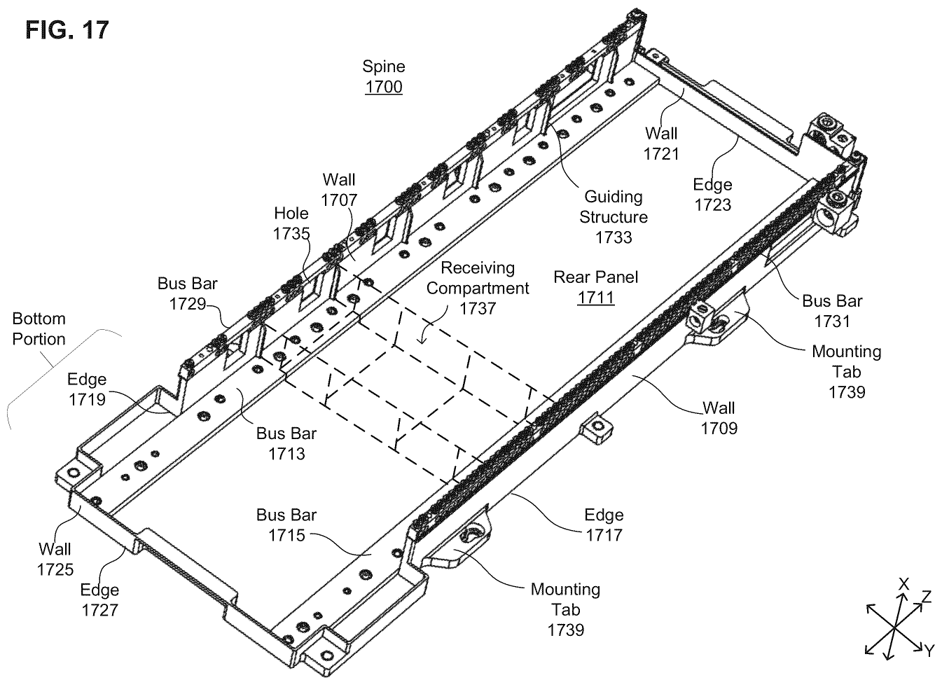

FIG. 9B is a front perspective view of second branch module 900 without the platform structure 935 or the interface panel 933 (which is on the platform structure). FIG. 9B illustrates track indentation 912, which is configured to receive a guiding structure of an electrical panel, for example a spine (e.g., guiding structure 1733 of FIG. 17). FIG. 9C is a front perspective view of the second branch module 900, where a portion of the enclosure is transparent to reveal components. FIG. 9D is an exploded front view of the second branch module 900 that illustrates the relays, joints, clips, PCBA, and back panel. FIG. 9E is a second exploded front view of the second branch module 900, where a portion of the enclosure is transparent. FIG. 9F is a third exploded front view of the second branch module 900, where a portion of the enclosure is transparent. In the example of FIG. 9F, the stab components have smaller body portions compared to the stab components in FIGS. 9C and 9E. The larger stab components in FIG. 9E may provide improved thermal performance compared to the stab components in FIG. 9F (e.g., due to the larger body portions having more surface area).

FIG. 9G is a rear perspective view of the second branch module 900. FIG. 9H is similar to FIG. 9G except a portion of the rear panel is transparent (note that the rear panel may be considered part of the enclosure). FIG. 9H illustrates the compactness of the second branch module 900. FIG. 9I is an exploded rear view of the second branch module 900, where portions of both bus bars are exposed. FIG. 9J is another exploded rear view of the second branch module 900.

Referring back to FIG. 9A, the second branch module 900 includes an upward facing interface panel 931 that allows a user to interact with the AFCI protection system. In this example, the AFCI panel includes a test button 927, a rest button 933, and displays 929 (e.g., e-ink displays) above and below the buttons (note that the displays are example status indicators). Status indicators, test buttons, and reset buttons are further described with respect to FIGS. 12 and 13.

Referring to FIG. 9I, the second branch module 900 includes two interlaced bus bars 913 and 920. Most of bus bar 913 is visible in FIG. 9I while only small portions of bus bar 920 are visible in FIG. 9I.

Referring to FIGS. 9C and 9H-9I, stab component 916 includes a flat body portion 915 above bus bar 913 and a portion of bus bar 920 (e.g., but not in direct contact with the bus bars), a first stab interface 911 that extends upward from a top surface of the body portion, and a second stab interface 912 that extends downward from a bottom surface of the body portion 915. The second stab interface 912 extends through a hole in the bus bar 913 to electrically couple to a relay. The first and second stab interfaces may be formed by subportions of the body portion 915 that are bent upward or downward (e.g., bending a subportion upward or downward may form a hole in the body portion 915). The remaining stab components in second branch module 900 may be the same or similar shapes, thus making the manufacturing process easier.

Bus bars 913 and 920 include flat body portions substantially parallel to the PCBA. The bus bars 913 and 920 also include holes to allow second interfaces (e.g., 912) of the stab components to pass through. The bus bars 913 and 920 also includes bus bar interfaces (e.g., 907) that extends downward from a bottom surface of the bus bar body portion. The bus bar interfaces may be formed by subportions of the bus bar body portion that are bent downward (e.g., bending a subportion of downward may form a hole in a bus bar).

The second branch module 900 also includes insulators (e.g., 914) that wrap around the second stab interfaces (e.g., 912) and bus bar interfaces (e.g., 907) below the bottom surface of the bus bars 913 and 920. The insulators help electrically isolate these interfaces from other electrical components (e.g., the PCBA). In the example of second branch module 900, each insulator includes walls that extend downward (−z direction) to wrap around three sides of an interface and partially around the fourth side. The opening on the fourth side allows joints (e.g., 909 and 910) to couple to the interfaces.

Referring to FIGS. 9C and 9H-9I, a set of components are electrically coupled as follows. Joint 909 couples the bus bar interface 907 to the relay 905. The current sensor 908 is coupled to joint 909 to sense current between the bus bar interface 907 and relay 905. The relay 905 and current sensor 908 are coupled to the PCBA panel (e.g., via hard connection). Joint 910 couples the relay 905 to the second stab interface 912.

More specifically, the bus bar interface 907 is part of bus bar 920 and extends downwards (−z direction) from a bottom surface of bus bar 920. A portion of the bus bar interface 907 is coupled to a portion of joint 909. The couple point of bus bar interface 907 and joint 909 is insulated from other components via insulator 914 (transparent in FIG. 9H) and clip joint 906 (also “clasp clip locator”). In some embodiments, the connection may be made via bolted joint (i.e., fastener) or via a welding manufacturing operation. Insulator 914 has walls extending in the −z direction that wrap around surfaces of the couple point facing the x and y directions. The clip joint 906 wraps around the bottom surface of the couple point and slides within the walls of insulator 914. The clip joint 906 and insulator 914 help insulate the couple point from other components (e.g., the PCBA). Joint 909 extends along the x axis (parallel to the bus bar 913) and bends in the −y direction to couple to a side of relay 905 facing the +y direction. The relay 905 has a rectangular prism shape and is positioned between bus bar interfaces and second stab interfaces. The relay 905 is oriented so its shortest edge is along the z axis, thus reducing the height of the panel (i.e., reducing the length along the z axis). A first segment of joint 910 extends in the −y direction from the side of the relay and bends in the x direction. A portion of joint 910 couples to a portion of second stab interface 912. Similar to the couple point described above, the couple point of joint 910 and interface 912 is insulated from other components via an insulator (transparent in FIG. 9H) and a clip joint. Thus, the arrangement of components allows electrical current to flow between the bus bar 920 and the first stab interface 911 (assuming the relay is closed). As illustrated, other pairs of bus bar interfaces and second stab interfaces are similarly electrically coupled to each other.

In the example of the second branch module 900: (1) bus bar interface 907 and second stab interface 912 are aligned with each other along the x axis; (2) each of the bus bar interfaces and second stab interfaces have tab shapes, where surfaces of the tabs face the ±y directions; (3) the four second stab interfaces are aligned with each other along the y axis; and (4) the column of four second stab interfaces are between two columns of bus bar interfaces (each bus bar column has two bus bar interfaces).

### Third Example Branch Module

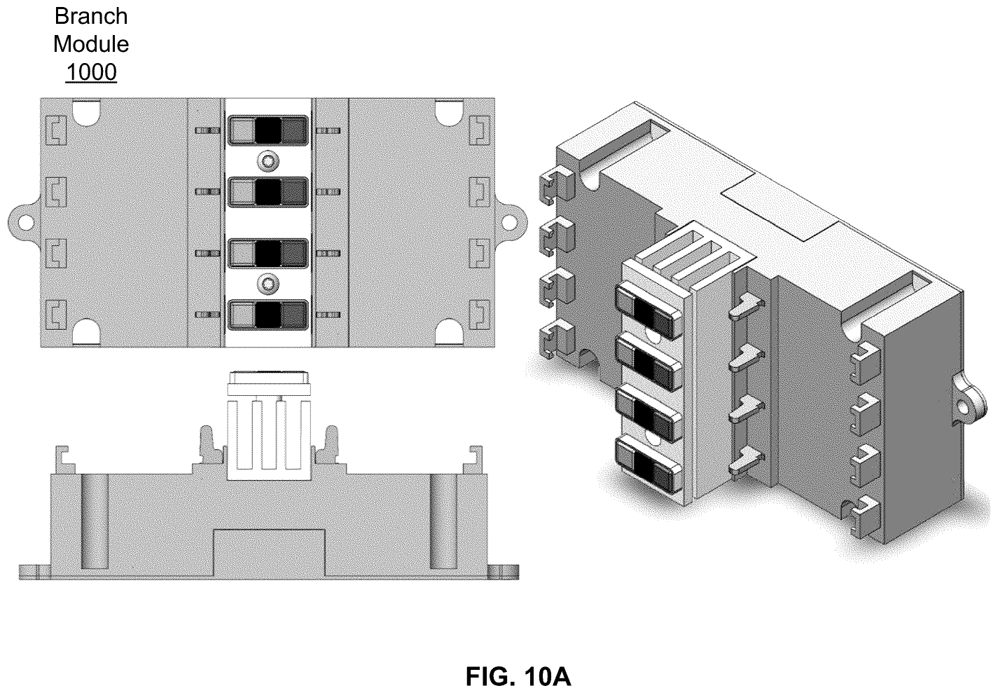

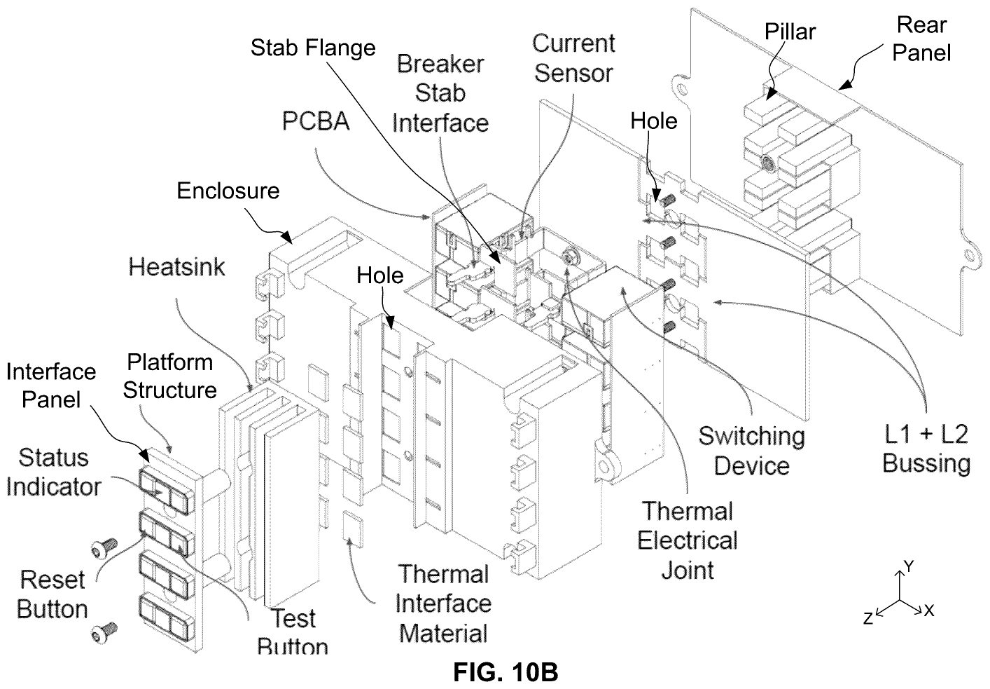

FIGS. 10A-10B (“FIG. 10” collectively) are diagrams of a third example branch module 1000. FIG. 10A includes a front view (top left), perspective view (right), and a bottom view (bottom left) of the third branch module 1000. FIG. 10B includes an exploded view of the third branch module 1000.

As illustrated, the third branch module 1000 has similar components as branch module 800. Additionally, components in the third branch module 1000 are arranged similarly to components in the branch module 800. For example, the third branch module 1000 includes joints that are coupled to bus bars and extend upward (+z direction). Furthermore, the joints include current sensors (e.g., 122, 322) and are coupled to interior sides of relays (e.g., 126, 326), and stab interfaces extend out of the same interior sides and extend upward to receive a circuit breaker. Third branch module 1000 also includes a PCBA panel (e.g., part of processing system 124, 324) coupled (e.g., hard connected) to each column of relays and corresponding current sensors. The surface of each PCBA panel faces the switching devices to make the third branch module 1000 more compact.

The third branch module 1000 includes an interface panel with four AFCI interface components that face upward (one for each relay). In this example, an AFCI interface component includes a test button, a rest button, and a status indicator (e.g., display) between the buttons. Status indicators, test buttons, and reset buttons are further described with respect to FIGS. 12 and 13. The interface panel is on a platform structure raised above the enclosure.

The third branch module 1000 includes a heatsink above the joints and between the columns of stab interfaces. The platform structure positions the interface panel above the heat sink, thus enabling the heat sink to improve thermal performance while the interface panel allows a user (e.g., a homeowner or technician) to interact with the AFCI protection system of the branch module 1000.

Among other advantages, the third branch module 1000 is configured to dissipate heat. Specifically, the stab interfaces in the third branch module 1000 include tabs (also “flanges”). The flanges have surfaces that face upwards. The enclosure includes holes that allow the flanges to couple to the heatsink. Specifically, thermal interface material couples the surfaces of the flanges to a bottom surface of the heatsink through the holes in the encloser. This is helpful because a significant portion of heat is generated at the stab interface during operation.

Additionally, the rear panel includes pillars that support the stab interfaces (note that the rear panel may be considered part of the enclosure). More specifically, the pillars extend through holes in the bus bars and between the relay joints to press against the bottom surface of the stab flanges. Due to this, the stab flanges are pinched between the pillars on the bottom surface and the thermal interface material on the top surface. Among other advantages, holding the stab flanges in place helps create additional mechanical support for the stab interfaces.

### Fourth Example Branch Module

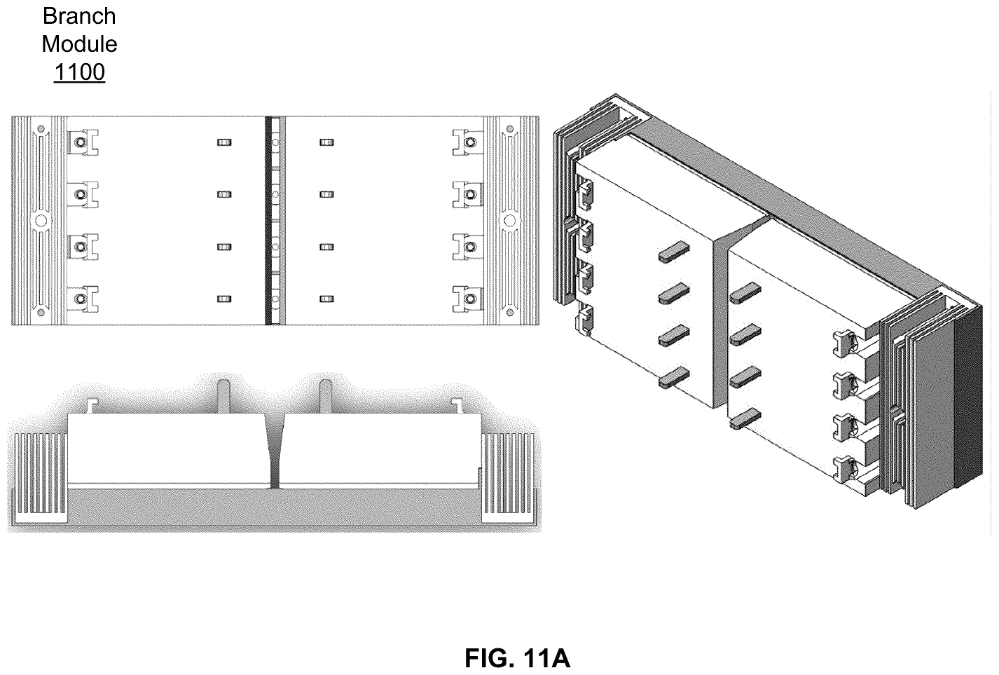

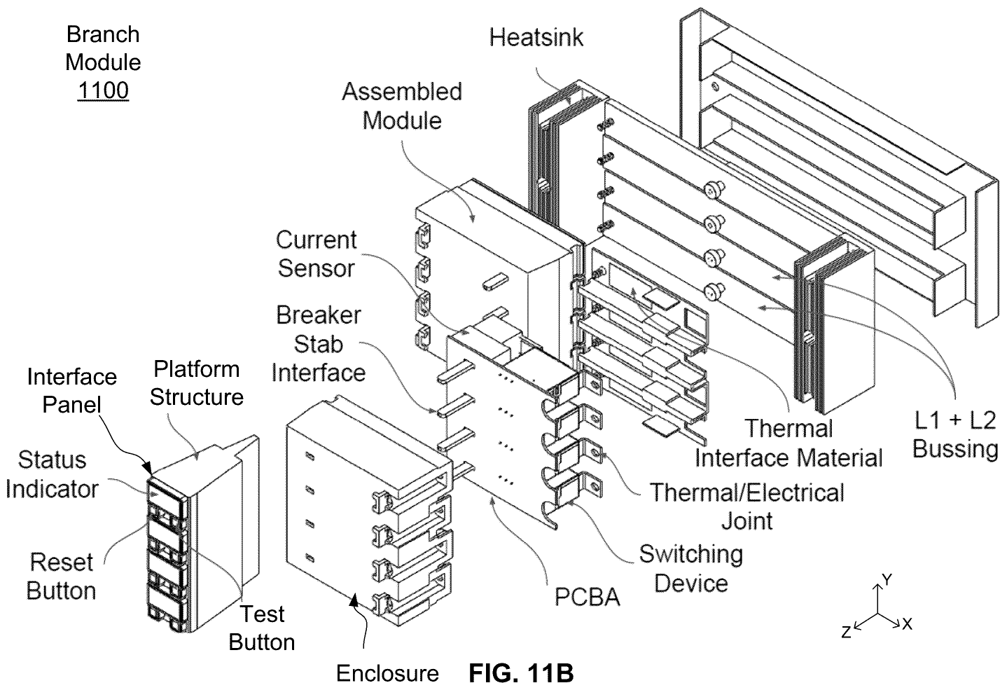

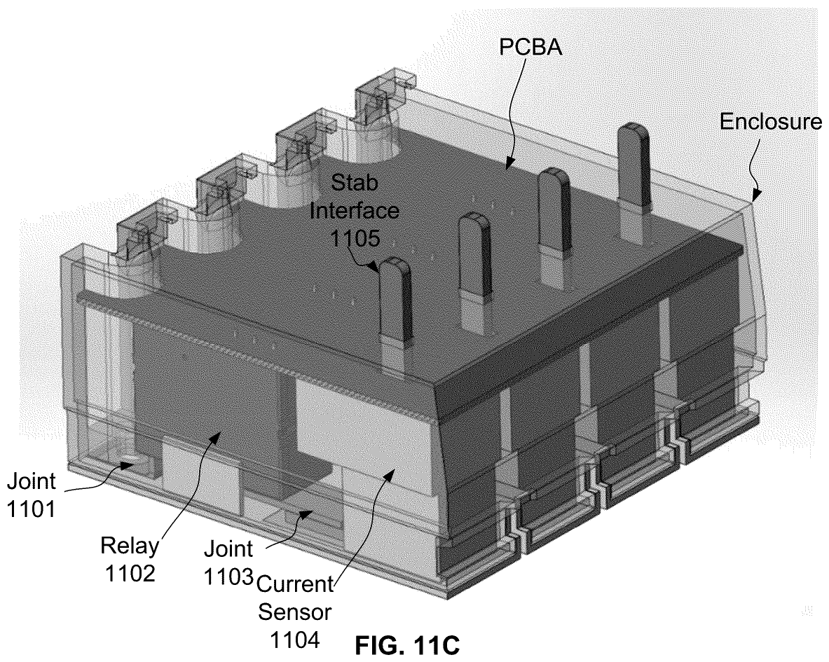

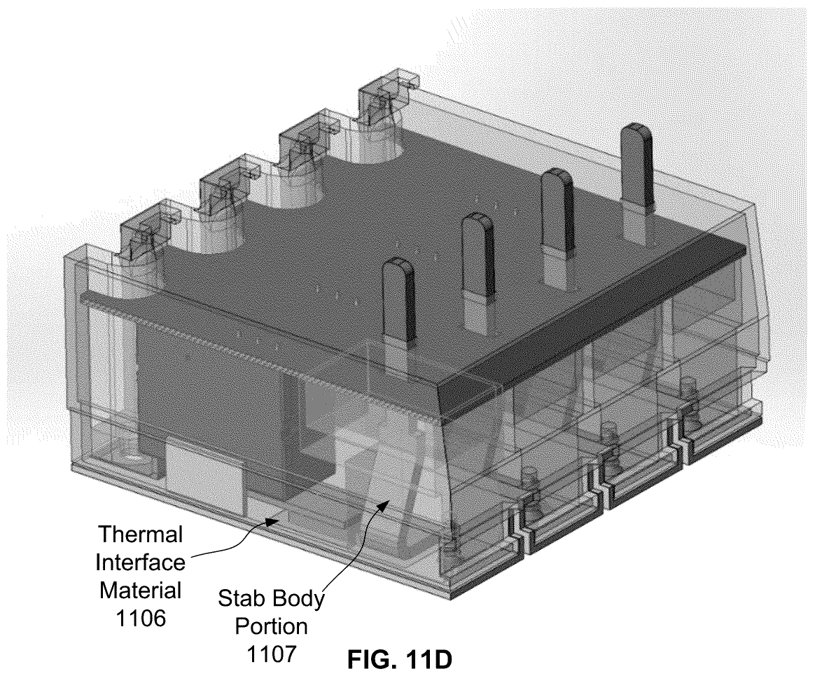

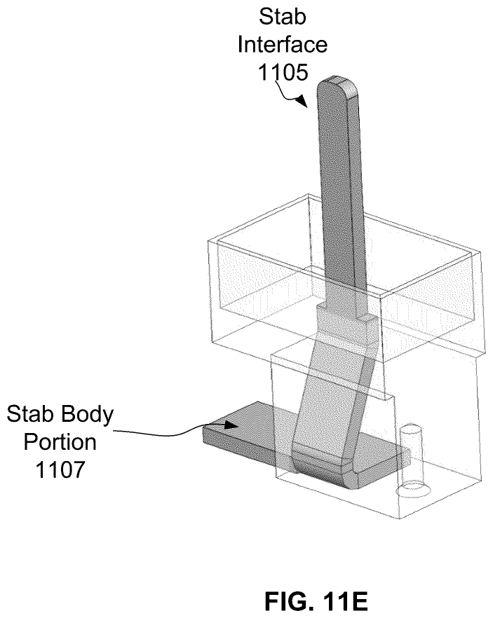

FIGS. 11A-11E (“FIG. 11” collectively) are diagrams of a fourth example branch module 1100. FIG. 11A includes a front view (top left), perspective view (right), and a bottom view (bottom left) of the fourth branch module 1100. FIG. 11B includes an exploded view of the fourth branch module 1100. Note that the platform structure and interface panel are omitted in FIG. 11A. FIG. 11C is a perspective view of an assembled module, where the enclosure is transparent. FIG. 11D is similar to FIG. 11C except the current sensor is transparent. FIG. 11E is a perspective view of a stab body portion. The fourth branch module 1100 can itself include modules, where, for example, a module only includes a single row of two or more relays (e.g., 126, 326) (e.g., see the assembled module in FIG. 11B). Thus, branch modules of various widths (along the x axis) can be constructed by including a desired number of modules (and adjusting the length of the bus bars along the x axis). For example, a thin branch module can be constructed by including a single column of modules, while a wide branch module can be constructed by including multiple columns of modules. The example in FIGS. 11A-11B illustrates a branch module with two columns of modules (one of the modules is labeled “assembled module” in FIG. 11B).

The bus bars of the fourth branch module 1100 include long interlaced (but unconnected) strip portions. The strips are so long that the columns of relays are over the interlaced strip portions (as viewed along the z axis). Among other advantages, the strips help reduce heat buildup due to their increased surface area. Furthermore, the heat sinks adjacent to the outer edges of the bus bars also helps dissipate heat.

Referring to FIGS. 11C-11E, joint 1101 electrically couples a bus bar to relay 1102. Joint 1103 electrically couples relay 1102 to the stab interface 1105. Joints 1101 and 1103 both couple to a bottom surface of relay 1102 that is substantially parallel to the surface of the bus bar. A bottom surface of the stab body portion 1107 is on thermal interface material 1106 to help dissipate heat. Current sensor 1104 (e.g., 122, 322) senses current flowing through the stab body portion 1107. In some embodiments, current sensor 1104 includes a current transformer to reduce heat generation (e.g., compared to a shunt current sensor).

In contrast to previous branch modules where joints are between columns of relays, the fourth branch module 1100 includes joints outside of the columns of relays. The joints are electrically coupled to the relays (e.g., 126, 326) (labeled “switching devices” in FIG. 11B).

Fourth branch module 1100 includes a PCBA panel (e.g., part of processing system 124, 324) configured to receive current sensor signals and control relays based on the signals. PCBA is above the relays and current sensor. The PCBA panel is oriented such that the panel surface is substantially parallel to the bus bars. The PCBA panel includes holes that allow the stab interfaces to pass through and interface with circuit breakers.

The interface panel of the fourth branch module 1100 is on the platform structure and includes four AFCI interface components that face upward (one for each relay). A base of the platform structure is between the two enclosures. In this example, each AFCI interface component of the interface panel includes a test button, a rest button, and a status indicator (e.g., display) above the buttons. Status indicators, test buttons, and reset buttons are further described with respect to FIGS. 12 and 13.

### Fifth and Sixth Example Branch Modules

FIGS. 12A-B (“FIG. 12” collectively) are a diagrams of a fifth example branch module 1200. Specifically, FIG. 12A is a perspective diagram of the branch module 1200 illustrating the front side of the module, and FIG. 12B is a magnified view of the interface panel 1285.

The module 1200 includes a receiving element 1201 (including a first portion 1205, a second portion 1207, and a middle portion 1208) configured to slide into one of a plurality of receiving compartments of a spine (e.g., spine 1700 of FIG. 17) and electrically couple to bus bars of the spine (e.g., bus bars 1729 and 1731 of FIG. 17). A receiving element may also be referred to as an “insertion element,” and a receiving compartment may also be referred to as a “slot” or “module slot.” Note that the receiving element 1201 is an example of an enclosure. In the example of FIG. 12, the branch circuit 1200 includes a track indentation 1209 (also “guide slot”) configured to receive a guiding structure of the spine (e.g., guiding structure 1733 of FIG. 17). A guiding structure may also be referred to as a “mounting structure” or “module guide.” As illustrated, the track indentation 1209 is part of an outer surface of the receiving element 1201.

The branch module 1200 also includes an AFCI protection system (not illustrated) housed in the receiving element 1201. As previously described with respect to FIGS. 1 and 3A-7, an AFCI protection system can detect arc fault events occurring in branch circuits and interrupt the flow of electricity in one or more of the branch circuits (when the branch module 1200 is part of an electrical panelboard). For example, the AFCI protection system in the receiving element 1201 includes current sensors (e.g., 122, 322), relays (e.g., 126, 326), and one or more PCBAs (e.g., part of processing system 124, 324).

The branch module 1200 also includes an interface panel 1285 on an exterior of the receiving element 1201. Similar to the previous interface panels previously described, the interface panel 1285 enables a user to interact with the AFCI protection system. In the example of FIG. 12, the interface panel 1285 includes, for each branch circuit (or for each switching device), sets of: (a) two interactable elements (e.g., 1287) and (b) a status indicator (e.g., 1213). The interface panel 1285 is on a mesa structure 1280 that protrudes away from the receiving element 1201.

In some embodiments, a status indicator (e.g., 1213) visually indicates the status of the corresponding branch circuit (e.g., the status indicator is a light source, and the color indicates the status). For example, the status indicator indicates whether an arc fault event was detected on the circuit or whether a relay (e.g., 126, 326) is open or closed.

One of the interactable elements (e.g., of each set) may be a reset element configured to, responsive to activation by the user, reset a functionality of the AFCI protection system responsible for one or more of the branch circuits (e.g., reset the switching device of a corresponding branch circuit). Another interactable element (e.g., of each set) may be a test element configured to, responsive to activation by the user, test a functionality of the AFCI protection system responsible for one or more of the branch circuits (e.g., test the capabilities of a switching device of a corresponding branch circuit).

FIG. 13 is a diagram of a section of a sixth example branch module 1300. The sixth branch module 1300 is similar to branch module 1200 (e.g., it includes a receiving element 1301 and a mesa structure 1380), except it includes a different interface panel. Specifically, while the interface panel 1285 of FIG. 12 includes sets of interactable elements and a status indicator for each branch circuit, the interface panel 1385 of FIG. 13 includes a single set of interactable elements 1387 and a status indicator 1313 (e.g., a display). These three components of the interface panel 1385 can be used to interact with the AFCI protection system for any of the corresponding branch circuits. For example, the status indicator 1313 may display the status of any of the corresponding branch circuits. In another example, the interactable elements 1387 can be used to test or rest the functionality of the AFCI protection system responsible for any of the corresponding branch circuits.

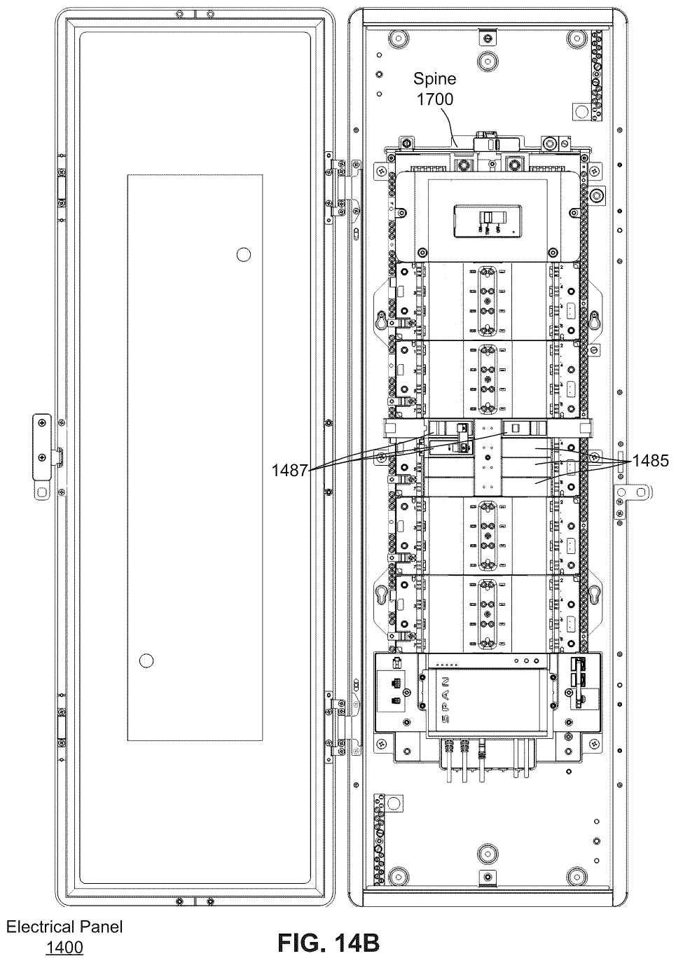

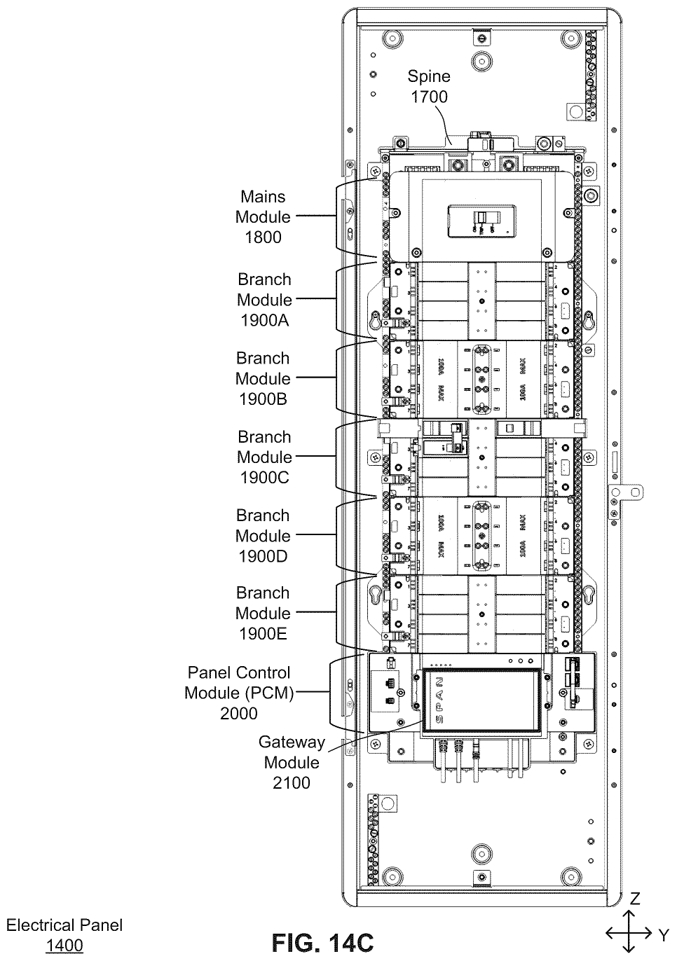

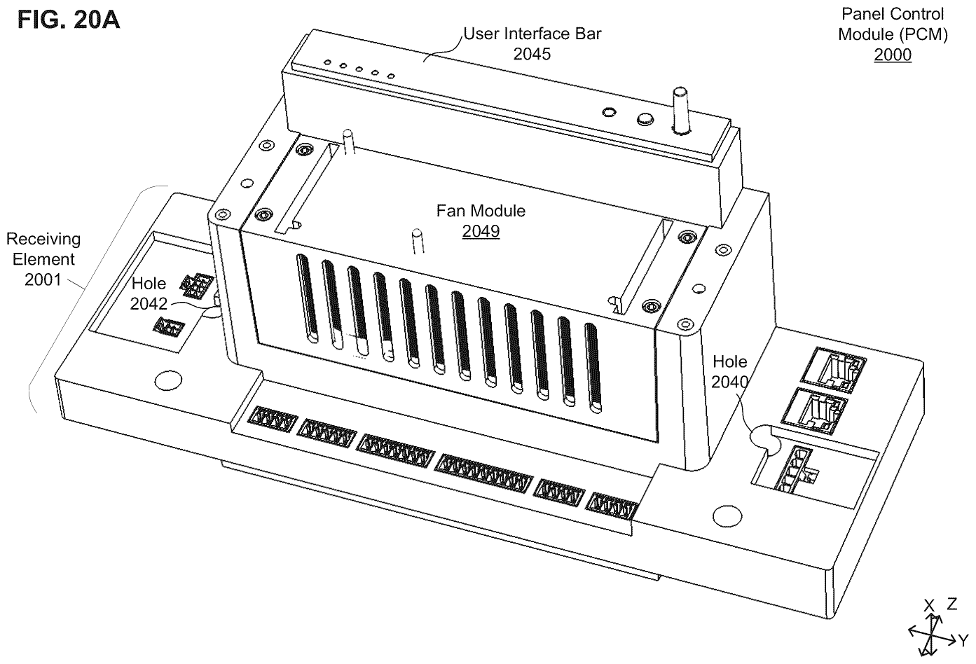

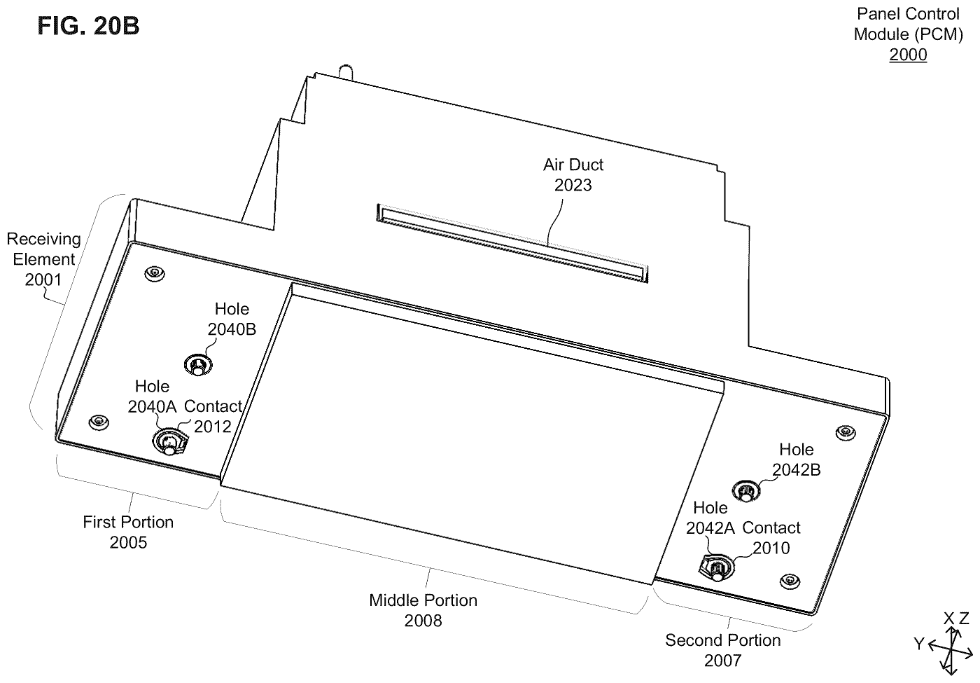

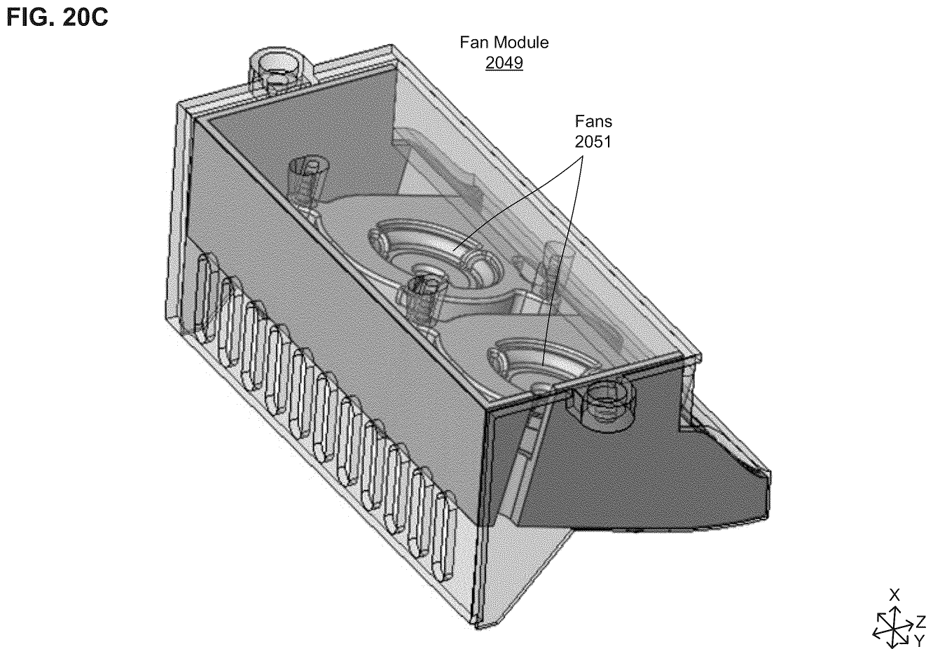

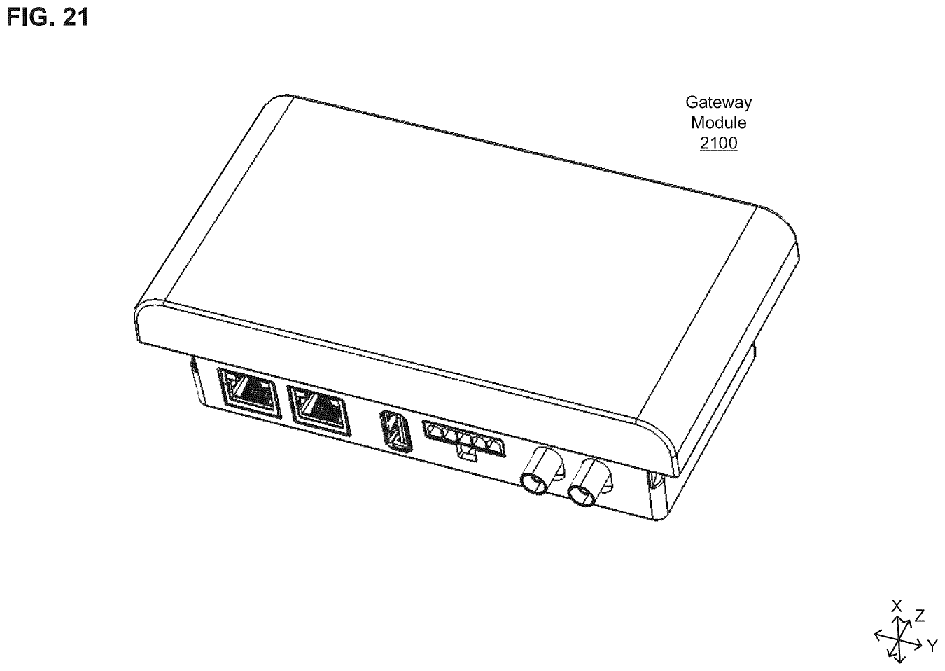

Descriptions of some components of the branch modules 1200 and 1300 are omitted in the above paragraphs for brevity. Additional descriptions of modular electrical components of an electrical panelboard (such as the first, second, and middle portions of the receiving elements) are further described below with respect to FIGS. 14A-22E.

As previously mentioned, any of the branch modules described above may be part of a modular assembly. For example, the components in FIG. 8A may form a modular unit configured to couple to one or similar modular units, where an electrical panelboard can include any number of modular units depending various considerations (e.g., the number of branch circuit terminals needed). Additional descriptions of a modular electrical panelboards and electrical modules (including branch modules) are further described below.

### Modular Electrical Panelboards

The following sections generally relate to modular chassis (e.g., modular electrical panels) and chassis modules (e.g., electrical components) for the modular chassis.

### INTRODUCTION

Continued electrification will add massive amounts of demand to electrical distribution. Estimates are that net distribution capacity in the U.S. will increase by two to three times to support fully renewable energy sources. The current distribution system and site-level (e.g., building) wiring are not well instrumented and not easily controllable. They are not well suited to implement sophisticated energy management.

Furthermore, many electrical panels for buildings (e.g., residential homes) are bulky, costly, and difficult to install, repair, replace, and upgrade.

Since conventional electrical panels on buildings (e.g., residential homes) are bulky, costly, and difficult to install, repair, replace, and upgrade, the following sections describe modular electrical panels with modular electrical components (also referred to as “electrical modules,” “chassis modules,” “modules,” or “electrical panel components”). These provide many advantages to installers and building owners: (1) the modular electrical panel can be rightsized for the usage needs of each building. For example, if a building will only use 16 branch circuits, the panel can be installed with just 16 branch circuits (e.g., instead of a larger number of circuits on a conventional preset panel), thus saving the building owner money. Additionally, an installer no longer needs to guess which components will be needed for a given building before arriving at the installation site. (2) The modular electrical components can be installed on many different types of electrical panels (e.g., used in different application settings). (3) The modular electrical components can be mass produced (since the same set of modules can be installed on many different types of electrical panels). (4) Individual modular electrical components are easily accessible and can be easily replaced on site without an installer removing large portions of the panel (e.g., without removing adjacent modules). (5) Modular electrical components on an electrical panel can be individually upgraded (e.g., with additional functionalities) without the replacing or upgrading the entire electrical panel (or large portions of the panel). Example modular electrical panels and modular electrical components that provide one or more of the above advantages are further described below.

FIGS. 14A-14C are diagrams illustrating front views of a physical embodiment of a modular electrical panel 1400. FIG. 14A is an end user's view of the panel 1400. In the end user view, most of the electrical components are not physically accessible because they are hidden in an enclosure 1475, under a dead front panel 1480, and under modular dead front panels 1485 (although the main breaker switch 1483 and switches for three overcurrent circuit breakers 1487 are accessible). FIG. 14B is a view of the electrical panel 1400 with the dead front panel 1480 removed and many of the modular dead front panels 1485 removed. FIG. 14B illustrates various electrical component modules installed in a spine 1700. FIG. 14C is a similar to FIG. 14B, except the door of the enclosure 1475 is removed and labels are added to the electrical modules. Specifically, in the example of FIG. 14C, the panel 1400 includes (from top to bottom) a mains module 1800, five branch modules (labeled 1900A-E), a panel control module (PCM) 2000, and a gateway module 2100.

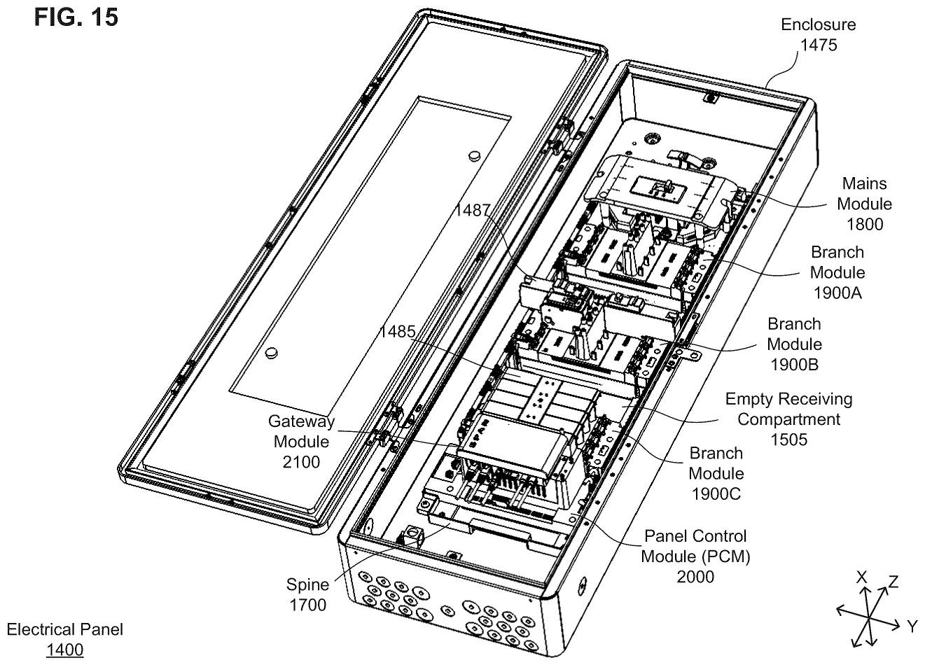

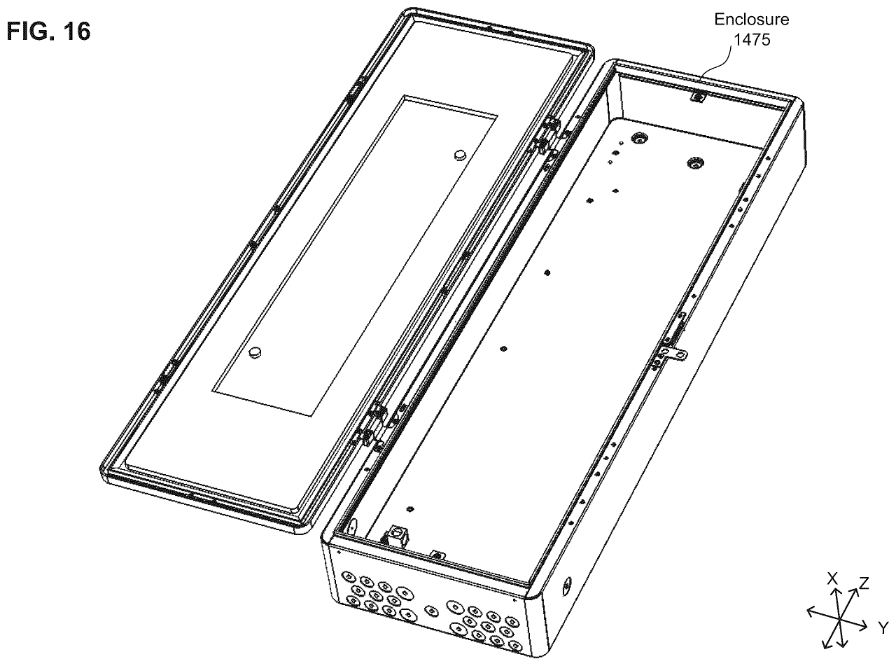

FIG. 15 is a perspective diagram of the electrical panel 1400 with a different arrangement of electrical modules. Specifically, in the example of FIG. 15, the panel 1400 includes (from top to bottom) a mains module 1800, branch modules 1900A-B, an empty module receiving compartment 1505, a branch module 1900C, a PCM 2000, and a gateway module 2100. FIG. 16 is a perspective diagram of the enclosure 1475 isolated from the spine and electrical modules.

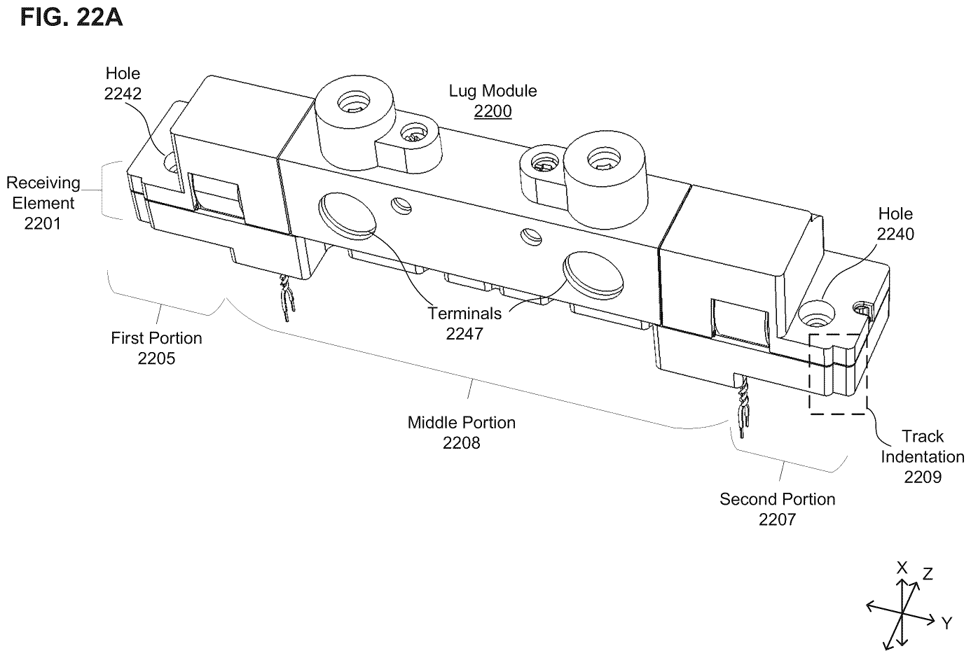

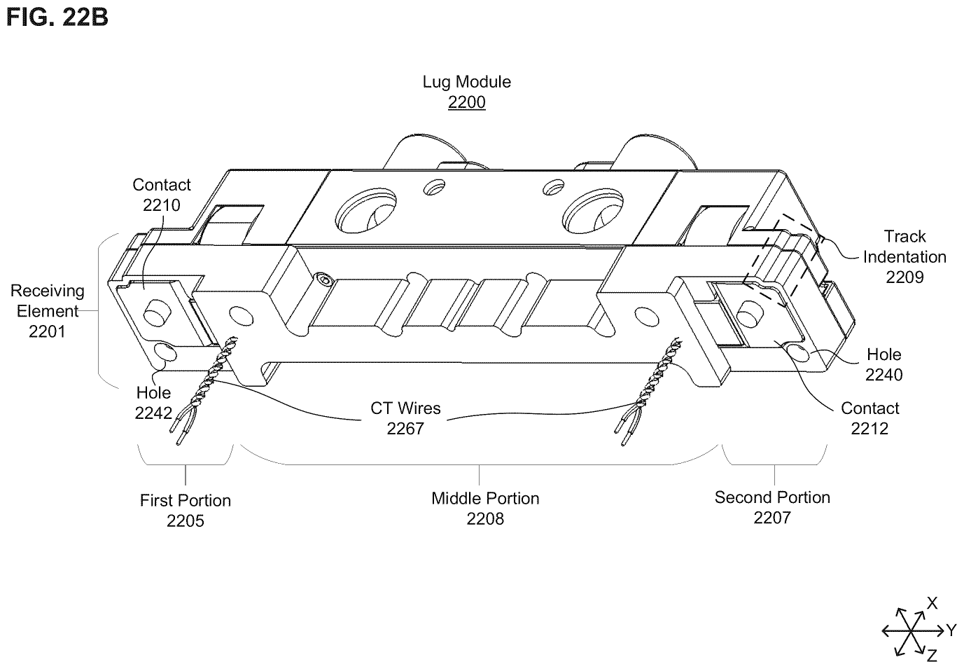

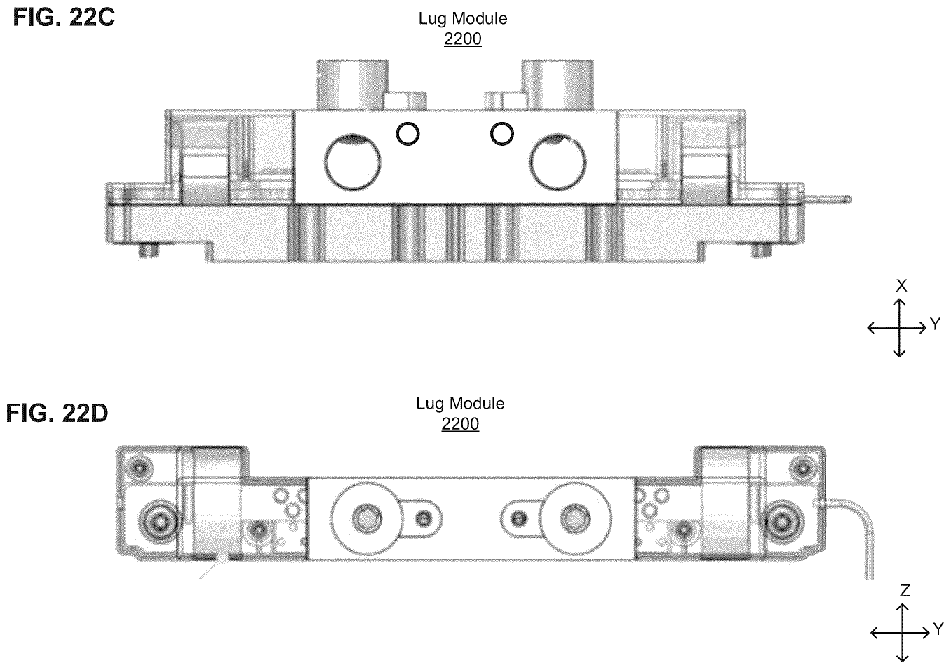

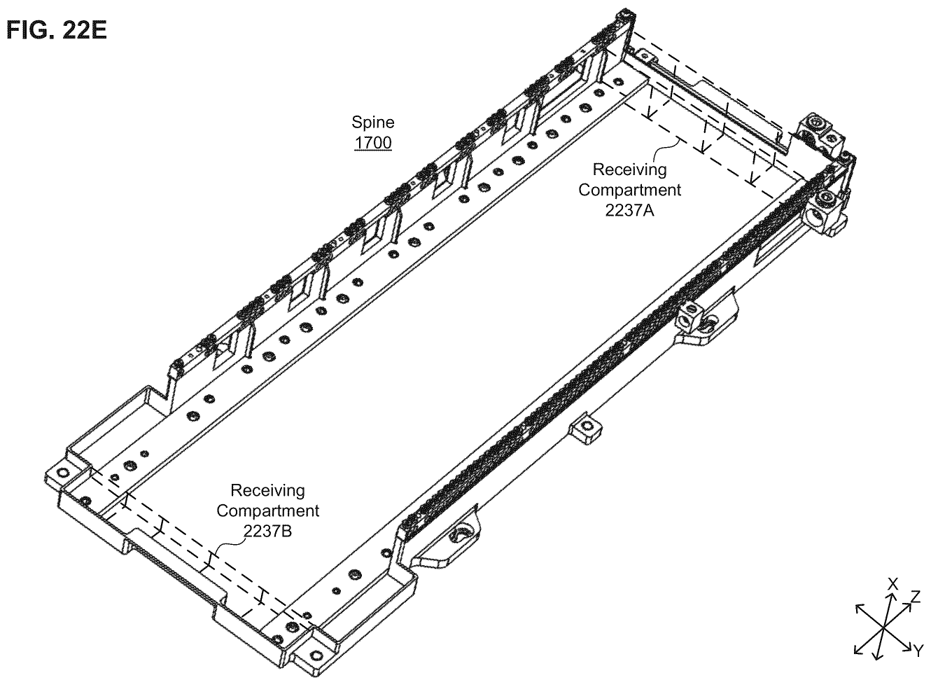

Although the following descriptions are generally in the context of electrical panel 1400, the descriptions are generally applicable to chassis that can receive modules and, more specifically, applicable to other types of electrical panels (e.g., the size of the panel and the number of modules may be different) which accommodate different electrical needs for different buildings. In a first example, a smaller panel includes three receiving compartments: a top receiving compartment with a mains module 1800, a middle receiving compartment with a branch module 1900, and a bottom receiving compartment with a PCM module 2000. In a second example, a panel includes a top receiving compartment with a lug module (described with respect to FIG. 22), three middle receiving compartments with branch modules 1900, and a bottom receiving compartment with a PCM module 2000.

The spine 1700 and the various electrical modules are further described below.

### Example Spines

FIG. 17 is a perspective diagram of the spine 1700 of the electrical panel 1400. The spine 1700 may be installed into the enclosure 1475 via mounting tabs 1739. The mounting tabs 1739 include keyhole features that can receive a fastener. The mounting tabs 1739 allow the spine 1700 to easily be placed into and removed from the enclosure 1475. Among other advantages, the spine 1700 can be installed upside down (e.g., rotated 180 degrees about the x-axis in FIG. 17). This enables the spin 1700 to be installed so that the feeder terminals (not labeled in FIG. 17) face the feeder wires regardless of whether the feeder wires are at the top or bottom (along the z-axis) of the enclosure.

In some embodiments, the spine 1700 with modules installed in receiving compartments weighs a total of fifty pounds or less so that a single person (instead of two or more people) can install the spine 1700 and the modules into the enclosure 1475, thus reducing installation costs.

Among other advantages, the spine 1700 includes receiving compartments (e.g., 1737) that can receive different modular electrical components. The receiving compartments (e.g., 1737) enable different types of electrical modules to be installed on the electrical panel 1400 (e.g., a branch module or a mains module) to accommodate the needs of the building. Said differently, an electrical module in a receiving compartment (e.g., a mains module) may be removed and replaced by an electrical module of a different type (e.g., a branch module). The receiving compartments are formed from the walls of the spin; bus bars 1713, 1715; and guiding structures (e.g., 1733) as further described below. Note that the spine 1700 can include additional of fewer receiving compartments than as illustrated in FIG. 17.

The spine 1700 includes a rear panel 1711 and walls 1707, 1721, 1709, 1725 that are raised (in the +x direction) from edges 1719, 1723, 1717, 1727 of the rear panel 1711 and that extend along their respective edges. For example, wall 1707 is raised from edge 1719 and extends along edge 1719. Similarly, wall 1709 is raised from edge 1717 (forming an opposite side of the spine 1700).

Although many receiving compartments of spine 1700 are the same size (or substantially the same size (e.g., the dimensions of the receiving compartments are within 10% of each other), a spine may include different sized receiving compartments to accommodate different sized modules. For example, along the z-axis a spine can include any combination of 1.5 inch, 2 inch, 4 inch, and 8 inch receiving compartments. Furthermore, in the example of FIG. 17, the width of the spine 1700 (along the y-axis) increases at a bottom portion. This creates a wider receiving compartment (relative to the other receiving compartments), thus enabling the spine 1700 to receive a wider electrical panel component (e.g., the PCM module 2000), which may otherwise not fit into other receiving compartments (e.g., 1737). Among other advantages, this wider receiving compartment further increases the customizability of the electrical panel 1400.

The spine 1700 includes two rectangular bus bars 1713, 1715 in the cavity formed from the walls (in other words, the bus bars 1713, 1715 are between the walls of the spine 1700). The bus bars 1713, 1715 are the L1 and L2 bus bars. The bus bars 1713, 1715 are coupled (e.g., secured or fixed) to the rear panel 1711 (e.g., via heat staking, snap-features, or fasteners). The bus bars 1713, 1715 are in corners formed by the rear panel 1711 and the walls 1707, 1721, 1709, 1725 (however this isn't required). Along the y-axis, the bus bars 1713, 1715 are spaced apart from each other and on opposite sides of the spine 1700. Along the z-axis, the bus bars 1713, 1715 extend along the length of the spine 1700. More specifically, each bus bar extends from wall 1721 to wall 1727 (however the bus bars are not required to extend the entire length of the spine 1700). Thus, in the example of FIG. 17, the bus bars 1713, 1715 are on opposite sides of receiving compartment 1737 (along the y-axis). The presence of both bus bars 1713, 1715 in a receiving compartment enables an electrical panel component (in the receiving compartment) to electrically couple to both bus bars 1713, 1715. Notably, the bus bars in the example of FIG. 17 do not include stabs.

The spine 1700 includes rectangular bus bars 1729, 1731 coupled to top surfaces of walls 1707 and 1709 (e.g., via heat staking, snap-features, or fasteners). One of the bus bars (e.g., 1729) may be a neutral bus bar and the other (e.g., 1731) may be a ground bus bar.

The spine 1700 includes multiple guiding structures (e.g., 1733). The guiding structures engage with modular electrical components when they are placed into receiving compartments of the spine and prevent modular electrical panel components in the receiving compartments from sliding into adjacent receiving compartments (e.g., prior to the modules being fixed to the bus bars). More specifically, the guiding structures engage with track indentations (e.g., on outer surfaces) of the of the modular electrical panel components as further described below.

The guiding structures may be fins or tabs that extend from inner surfaces of walls 1707 and 1709. To give a specific example, the guiding structure 1733 is raised from an inner surface of wall 1707 and extends toward the inner surface of wall 1709, which is opposite wall 1707 (in this context, “inner” is relative to the cavity of the spine 1700). Each receiving compartment includes a set of one or more (e.g., four) guiding structures (e.g., in corners of the receiving compartments). In the example of FIG. 17, the guiding structures on wall 1707 are aligned (along the z-axis) with guiding structures on wall 1709 (not illustrated in FIG. 17).

Installing an electrical module may include placing (e.g., sliding) the module in a receiving compartment and securing the module into the receiving compartment (e.g., so the component remains fixed to and electrically coupled to both bus bars). A module may be secured to the spine 1700 via bolts or screws with fasteners (which may improve heat rejection). Thus, in the example of FIG. 17, the bus bars 1713, 1715 include a set of holes (to receive bolts or screws) for each of the receiving compartments so the modules can be directly secured to the bus bars 1713, 1715. The holes may have a standard and repeating hole pattern corresponding to the receiving compartment positions so that different modules can be secured to the bus bars regardless of which receiving compartment they are placed into. In some embodiments, spring loaded clips are used in addition to or alternative to bolts.

In some embodiments, the modules in the receiving compartments may be independently powered and communicate with one another. In order to achieve this, a wired connection may be installed between modules to provide DC voltage and signals (e.g., over a CAN bus interface or the like) (the connection may carry 3.3V or 5V). Thus, one or more of the side walls (1707 and 1709) may include one or more holes (or “cavities”) (e.g., 1735) aligned with the receiving compartments (e.g., 1735) for wires of these connections (e.g., each receiving compartment may include at least one corresponding hole in a side wall). Among other advantages, these side wall holes (e.g., 1735) ease installation of the wired connections.

Although the above descriptions with respect to FIG. 17 describe many features, a spine is not required to include all of these features. For example, some spine embodiments may not include: all four walls 1707, 1709, 1721, 1725; guiding structures 1733, mounting tabs 1739, holes one or both of the bus bars 1713, 1715 (for mounting the modules); or some combination thereof.

### Example Mains Modules

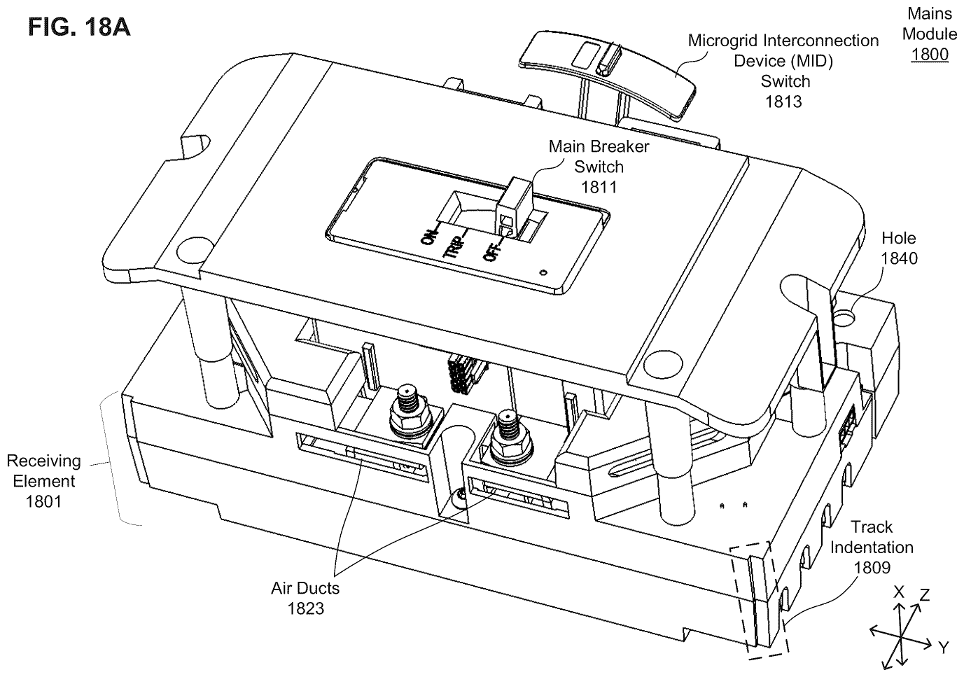

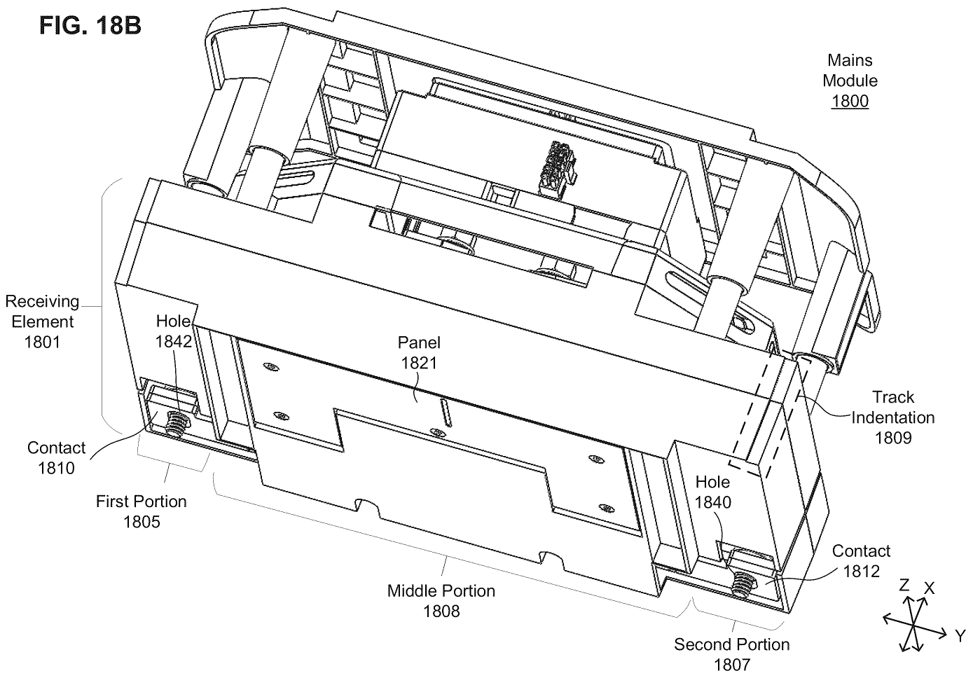

In some embodiments, the electrical panel 1400 includes a mains module 1800. The mains module 1800 is a modular electrical panel component that may be installed into one (e.g., of many) of the receiving compartments of the spine 1700 (however, practically the mains module 1800 may be installed into one of the top receiving compartments of the spine to couple to the feeder wires). FIGS. 18A-B (“FIG. 18” collectively) are diagrams of an example mains module 1800. Specifically, FIG. 18A is a perspective diagram of an example mains module 1800 illustrating the front side of the module 1800. FIG. 18B is a perspective diagram of the mains module 1800 illustrating the back side of the module 1800 (that engages with the spine 1700).

The mains module 1800 may include the main breaker of the panel 1400, a MID (Microgrid Interconnection Device), or some combination thereof (e.g., no main breaker and no MID). In the example of FIG. 18, the mains module includes a main breaker and a MID (e.g., see switches 1811 and 1813 in FIG. 18A). The mains module 1800 may provide a location to connect the main feeders to the panel 1400 (and thus provide power to the bus bars 1713, 1715), provide overcurrent protection, and/or a disconnect. The mains module 1800 may be rated up to 200 amps. If the mains module 1800 includes an MID, the MID allows the panel 1400 to isolate itself from the grid.

The mains module 1800 includes a receiving element 1801. The receiving element 1801 is a container or cartridge shaped to slide into a module receiving compartment of the spine 1700 (e.g., one of many receiving compartments) and be fixed to the bus bars in the receiving compartment. The receiving element 1801 includes a first portion 1805 on a first side of the receiving element 1801, a second portion 1807 on a second side of the receiving element 1801 (e.g., an opposite side (along the y-axis)), and a middle portion 1808 between the first and second portions. The first portion 1805 receives and directly couples to a first bus bar (e.g., 1715). Similarly, the second portion 1807 receives and directly couples to a second bus bar (e.g., 1713). Since the bus bars 1713, 1715 may pass through the receiving compartments, the first and second portions may extend along the length of the mains module 1800 (along the z-axis) to accommodate each bus bar.

The first portion 1805 includes a metal electrical contact (also “bus bar contact”) 1810 and the second portion 1807 include an electrical contact 1812. Both contacts 1810, 1812 physically contact a bus bar of the spine 1700 (when the module 1800 is in a receiving compartment).

As previously described, a module (e.g., the mains module 1800) may be secured to (bus bars of) the spine 1700 via bolts or screws. Thus, the receiving element 1801 (e.g., the first and second portions) may include a set of holes to receive bolts or screws. For example, see holes 1840, 1842 in FIGS. 18A and 18B. The holes may have a (e.g., standard) pattern or arrangement on the receiving element 1801 that matches the hole pattern of the bus bars.

The receiving element 1801 includes a middle portion 1808 between the first and second portions 1805, 1807. In the example of FIGS. 18A and 18B, the middle portion 1808 extends along the −x direction farther than the first and second portions 1805, 1807. Thus, the middle portion 1808 engages with a gap between the bus bars 1713, 1715 when the receiving element 1801 is in a receiving compartment. In the example of FIG. 18B, the middle portion 1808 includes an (e.g., aluminum) panel 1821 to increase heat dissipation during operation of the panel 1400. The middle portion 1808 also includes air ducts 1823. The air ducts 1823 allow air to pass through internal components of the mains module 1800 to further improve heat management. Other modules may include similar air ducts so that, when installed on a panel, the air ducts of each module align with each other to create a long airflow passage along the panel 1400. A fan module 2049 in the PCM 2000 may create an air current through the module air ducts (the fan module is further described with respect to FIG. 7C).

The receiving element 1801 also includes track indentations (e.g., 1809) that extends along the sliding direction of the receiving compartment (which is along the x-axis in the figures). As illustrated, the track indentation 1809 is on an external surface of the receiving element 1801 (however, this is not required). The track indentation 1809 is configured to engage with a guiding structure (e.g., 1733) of the spine 1700 to (a) guide placement of the mains module 1800 into the modular spot and retain the mains module 1800 in the receiving compartment after placement. Thus, the receiving element 1801 may include one or more track indentations (e.g., four) aligned with an arrangement of one or more guiding structures in a receiving compartment. In the example of the mains module 1800, the receiving element 1801 includes track indentations at corners of the receiving element 1801.

Although not illustrated in FIG. 18, the receiving element 1801 may include a port for a wired connection. The port is on a side parallel to the xz plane. When the receiving element 1801 is in a receiving compartment of the spine 1700, the port is on a side of the receiving element 1801 facing wall 1707 and aligned with a hole (e.g., 1735), which allows an installer to connect the wire to the port to establish the connection. As previously described, the wired connection may provide DC voltage and signals (e.g., over a CAN bus interface or the like) to and/or from the module 1800.

### Example Branch Modules

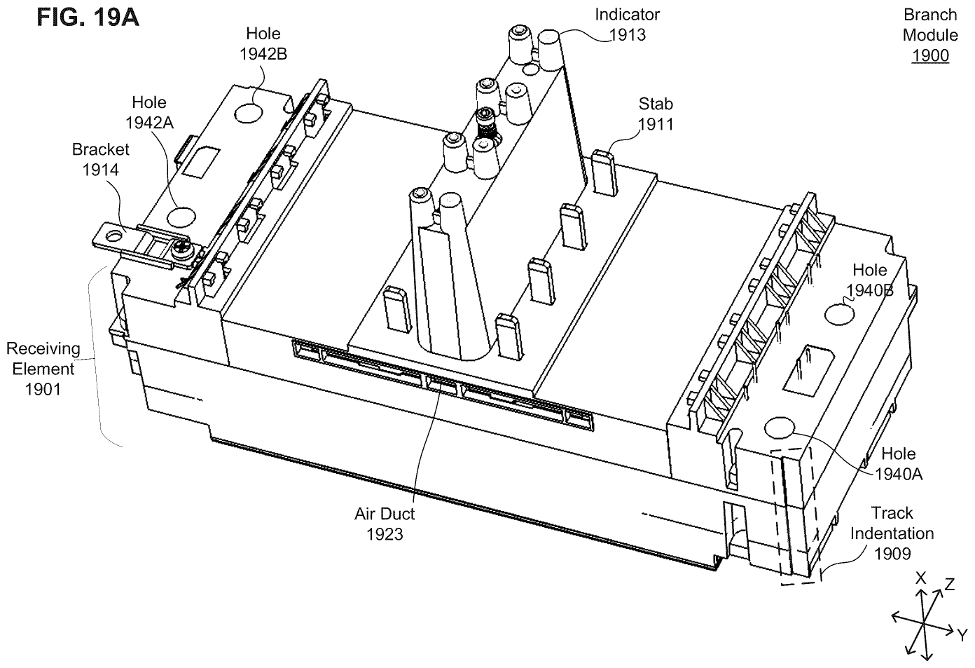

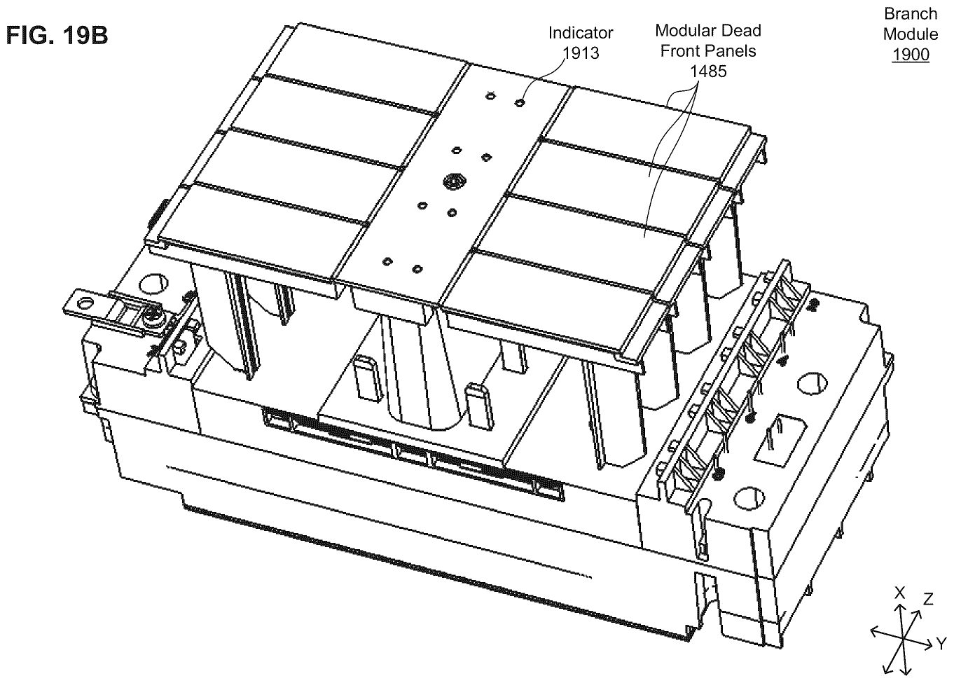

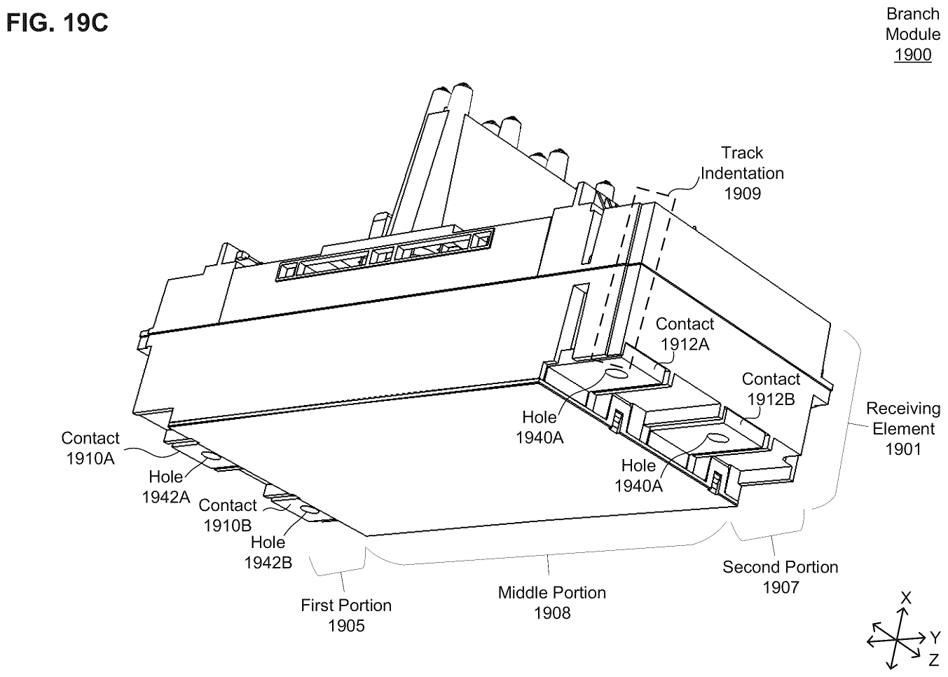

In some embodiments, the electrical panel 1400 includes a branch module 1900. The branch module 1900 is a modular electrical panel component that may be installed into one (e.g., of many) of the receiving compartments of the spine 1700. Since a building (e.g., a residential building) may include many circuits, a panel may include multiple branch modules 1900 to accommodate the expected electrical needs of the building. FIGS. 19A-C(“FIG. 19” collectively) are diagrams of an example seventh branch module 1900. Specifically, FIG. 19A is a perspective diagram of the branch module 1900 illustrating the front side of the module. FIG. 19B is similar to FIG. 19A, except the branch module 1900 additionally includes modular dead front panels 1485. FIG. 19C is a perspective diagram of the branch module 1900 illustrating the back side of the module (that engages with the spine 1700).

Similar to the receiving element 1801 of the mains module 1800, the receiving element 1901 of the branch module 1900 includes a first portion 1905, a middle portion 1908, a second portion 1907, track indentations (e.g., 1909), a port for a wired connection (not illustrated) and an air duct 1923 with similar mechanical configurations and functionalities. Due to this, descriptions of these components are omitted for brevity. The receiving element 1909 also includes electrical contacts 1910, 1912 and holes 1942, 1940 at the first and second portions 1905, 1907 (similar to the receiving element 1801), however, unlike the receiving element 1801, the receiving element 1909 includes two electrical contacts 1910A, 1910B and two holes 1942A, 1942B at the first portion 1905 and includes two electrical contacts 1912A, 1912B and two holes 1940A, 1940B at the second portion 1907 (for a total of four electrical contacts that contact bus bars of the spine 1700 and a total of four holes to receive bolts or screws that secure the contacts to the bus bars). Similar to the receiving element 1801, the holes of the receiving element 1901 may have a (e.g., standard) pattern that matches the hole pattern of the bus bars.

The example branch module 1900 includes components to establish eight switched circuit branches (however additional or fewer circuits are possible). Each stab (e.g., stab 1911) can engage with an overcurrent circuit breaker installed on the branch module 1900. In some embodiments, the branch module 1900 is rated up to 200 amps. The branch module 1900 may include additional branch circuit functionalities, such as current or voltage sensing (e.g., via sensors 122, 322), AFCI protection (e.g., via an AFCI protection system in the receiving element 1901), light (e.g., LED) indication, or some combination thereof for each of the circuit branches.

The modular dead front panels 1485 provide touch-safe interfaces to homeowners. Additionally, the panels 1485 can be individually removed (e.g., snapped off) from each other and from the branch module 1900 to accommodate additional overcurrent circuit breakers as the breakers are installed on the module 1900.

The branch module 1900 includes a bracket 1914 protruding from a top surface to contact a neutral bus bar (e.g., 1729) of the spine (e.g., to enable current or voltage metering). The bracket 1914 may be bolted to the neutral bus bar.

The branch module 1900 includes a status indicator (e.g., indicator 1913) for each of the circuit branches. In the example of FIG. 19, each indicator includes a light source (e.g., an LED) in the branch module 1900 and a light pipe that directs light from the source to the external environment. Each indicator may illuminate light indicating the state of a relay in the associated circuit branch (e.g., a green light indicates the relay is closed). As illustrated in FIG. 19B, the indicators can be seen through the dead front. Thus, the indicators may allow a user to easily and quickly determine the states of each relay of the branch module 1900.

### Example PCMs (Panel Control Modules)

In some embodiments, the electrical panel 1400 includes a PCM (panel control module) 2000. The PCM 2000 is a modular electrical component that may be installed in a receiving compartment of the spine 1700. Since the example PCM 2000 is wider than other modules, the PCM 2000 may be installed on the wide receiving compartment of spine 1700 (at the bottom portion). FIGS. 7A-B (“FIG. 7” collectively) are diagrams of an example PCM (panel control module) 2000. FIG. 7A is a perspective diagram of the PCM 2000 illustrating the front side of the module 2000. FIG. 7B is a perspective diagram of the PCM 2000 illustrating the back side of the module 2000 (that engages with the spine 1700).

In general, the PCM 2000 manages control of the electrical panel 1400. For example, the PCM 2000 performs computations (e.g., for powerup functionalities) and provides power to the other modules on the panel 1400. The PCM 2000 includes a user interface (UI) bar 2045 which may give users (e.g., a homeowner) the ability to read the state of the panel 1400 and interact with and control the panel 1400.

As previously discussed, the PCM 2000 includes a fan module 2049. FIG. 7C is a transparent perspective diagram of an example fan module 2049 that fits into the PCM 2000. The fan module 2049 includes two fans that create airflow through air duct 2023 to increase dissipation throughout the panel 1400.

Similar to the receiving element 1801 and the receiving element 1901, the receiving element 2001 of the PCM 2000 includes a first portion 2005, a middle portion 2008, a second portion 2007, an air duct 2023, electrical contacts 2010, 2012, a port for a wired connection, and holes 742A-B, 740A-B with similar mechanical configurations and functionalities (note that in FIG. 7B, bolts are in holes 740A-B, 742A-B). Due to this, descriptions of these components are omitted for brevity. That being said, note that the PCM 2000 does not include track indentations since the PCM 2000 is shaped to slide into the wide receiving compartment of the spine 1700.

### Example Gateway Modules

In some embodiments, the panel 1400 includes a gateway module that couples to the PCM 2000. FIG. 8 is a perspective diagram of an example gateway module 2100. The gateway module 2100 is a site controller for a building (e.g., a residential home). If the building includes multiple panels, the gateway module 2100 can receive and aggregate data from the multiple panels and determine building-wide control decisions and reports (thus, a building with multiple panels may only use a single gateway module). For example, the gateway module 2100 determines decisions for powerup and can send panel reports to a cloud server (pending user permissions). The gateway module 2100 may include computer components associated with the above functions, such as a set of processors, a computer readable medium, and antennas.

### Example Lug Modules

In some embodiments, the electrical panel 1400 includes a lug module 2200. The lug module 2200 is a modular electrical panel component that may be installed into one (e.g., of several) of receiving compartments of the spine 1700. FIGS. 22A-D are diagrams of an example lug module 2200. Specifically, FIG. 22A is a perspective diagram of the lug module 2200 illustrating the front side of the module 2200. FIG. 22B is a perspective diagram of the lug module 2200 illustrating the back side of the module 2200 (that engages with the spine 1700). FIG. 22C is a lateral side view of the module 2200, and FIG. 22D is a front view of the module 2200. FIG. 22E is a diagram illustrating example lug module receiving compartments 2237A-B of the spine 1700. Note that FIGS. 22A-E may collectively be referred to as FIG. 22.

The panel 1400 may include a lug module 2200 when the panel doesn't include a mains module 1800. The lug module 2200 provides power from the feeder wires to the bus bars 1713, 1715. To do this, the lug module 2200 may be installed in a top receiving compartment 2237A or a bottom receiving compartment 2237B of the spine 1700. Since the lug module 2200 is typically smaller (along that z-axis) than other modules (e.g., a branch module 1900), the receiving compartments 2237A-B may be smaller (along the z-axis) to accommodate lug modules. The lug module 2200 includes terminals 2247 for the feeder wires and electrical contacts 2210, 2212 to power the bus bars 1713, 1715. In some embodiments, the lug module 2200 is a metered (e.g., the CT wires 2267 transmit current measurement data (e.g., to the PCM module)), which allows it to provide powerup functionality. The lug module 2200 may be rated up to 200 amps.

Similar to receiving elements 1801 and 1901, the receiving element 2201 of the lug module 2200 includes a first portion 2205, a middle portion 2208, a second portion 2207, track indentations (e.g., 2209), electrical contacts 2210, 2212 (two in total), and holes 2242, 2240 (two in total) with similar mechanical configurations and functionalities. Due to this, descriptions of these components are omitted for brevity.

Although the above module descriptions with respect to FIGS. 18-20 and 22 describe many features, an electrical module is not required to include all of these features. For example, some electrical module embodiments may not include: a first portion (e.g., 1805), a second portion (e.g., 1807), a middle portion (e.g., 1808), holes (e.g., 1840, 1842), track indentations (e.g., 1809), contacts (e.g., 1810, 1812), or some combination thereof.

### Additional Spine Examples

Although FIG. 17 provides an example spine 1700, the below paragraphs describe additional example spines. The spines described below may omit features illustrated in FIG. 17 and/or include features that are in addition to or alternative to the features illustrated in FIG. 17.

In some embodiments, a spine (e.g., 1700) of a chassis (e.g., electrical panel 1400) includes receiving compartments (e.g., 1737) configured to receive chassis modules (e.g., 1800, 1900, 2000, 2200). Each receiving compartment is formed by (a) a portion of a panel (e.g., 1711); (b) a portion of a wall (e.g., 1707) raised from a first edge (e.g., 1719) of the panel and extending along the first edge; (c) portions of two bus bars (e.g., 1713, 1715) spaced apart from each other and fixed to the panel; and (d) guiding structures (e.g., 1733) extending from a surface of the first wall. The guiding structures (a) engage with chassis modules and (b) prevent the received chassis modules from sliding into an adjacent receiving compartment.

In some embodiments, a spine (e.g., 1700) of a chassis (e.g., electrical panel 1400) includes: (a) a back panel (e.g., 1711); (b) a side wall (e.g., 1735) extending from an edge (e.g., 1719) of the back panel; (c) two bus bars (e.g., 1713, 1715) that are spaced apart from each other, fixed to the back panel, and run parallel to the side wall; and (d) guide structures (e.g., 1733) extending from the side wall and/or at fixed positions relative to the bus bars. The guide structures define receiving compartments (e.g., 1737) for attaching chassis modules (e.g., 1800, 1900, 2000, 2200) across the two bus bars, and the receiving compartments are configured for field installation of the chassis modules.

In some embodiments, a spine (e.g., 1700) of a chassis (e.g., electrical panel 1400) includes: (a) a back panel (e.g., 1711); (b) two bus bars (e.g., 1713, 1715) that are spaced apart from each other, fixed to the back panel, and run parallel to the side wall; and (d) guide structures (e.g., 1733) located at fixed positions relative to the bus bars. The guide structures define receiving compartments (e.g., 1737) for attaching chassis modules (e.g., 1800, 1900, 2000, 2200) across the two bus bars, and the receiving compartments are configured for field installation of the chassis modules.

In some embodiments, a spine (e.g., 1700) of a chassis (e.g., electrical panel 1400) includes: (a) a back panel (e.g., 1711); (b) a side wall (e.g., 1735) extending from an edge (e.g., 1719) of the back panel; (c) two bus bars (e.g., 1713, 1715) that are spaced apart from each other, fixed to the back panel, and run parallel to the side wall; and (d) guide structures (e.g., 1733) extending from the side wall. The guide structures define receiving compartments (e.g., 1737) for attaching chassis modules (e.g., 1800, 1900, 2000, 2200) across the two bus bars. The receiving compartments are for field installation of the chassis modules. For each receiving compartment: the two bus bars contain a hole pattern for attachment of the chassis module to the two bus bars, and the side wall includes an opening (e.g., 1735) to pass an electrical connection that provides data and/or power to the chassis module.

In some embodiments, a spine (e.g., 1700) of a chassis (e.g., electrical panel 1400) includes: (a) a back panel (e.g., 1711); (b) two bus bars (e.g., 1713, 1715) spaced apart from each other and fixed to the back panel, each bus bar including holes along a length of the bus bar and aligned with holes on the other bus bar, where a set of aligned holes are configured to receive bolts that hold a chassis module in physical contact to the bus bars; (c) a wall (e.g., 1707) raised from a first edge (e.g., 1719) of the back panel and extending along the first edge. The wall includes cavities (e.g., 1735) spaced along the length of the wall and at locations relative to holes of the bus bars.

In some embodiments, one or more (e.g., each) receiving compartment is additionally formed by a portion of a second wall (e.g., 1709) raised from a second edge (e.g., 1717) of the panel and extending along the second edge. Each receiving compartment may be additionally formed by one or more guiding structures extending from a surface of the second wall facing the first wall (e.g., 1707).

The spine (e.g., 1700) may further include a neutral bus bar (e.g., 1729) or a ground bus bar (e.g., 1731) fixed to a top surface of the wall (e.g., 1707 or 1709).

The guiding structures may be configured to engage with an outer surface of a chassis module (e.g., an outer surface of receiving element). For example, guiding structures are configured to engage with track indentations (e.g., 1809, 1909, 909) of chassis modules.

### Additional Module Examples

The below paragraphs describe additional example modules. The modules described below may omit features illustrated in previous figures and/or include features that are in addition to or alternative to the features illustrated in previous figures.

In some embodiments, a chassis module (e.g., 1800, 1900, 2000, 2200) for a chassis (e.g., a modular electrical panel 1400) includes an insertion element (e.g., 1801, 1901, 701, 901) configured to slide into one of a plurality of receiving compartments (e.g., 1737) of a spine (e.g., 1700) of the chassis. The insertion element includes: a first electrical contact (e.g., 1810, 1910, 2210), a first hole (e.g., 1842, 1942, 2242), a second electrical contact (e.g., 1812, 1912, 2212), and a second hole (e.g., 1840, 1940, 2240). The first contact is on a first side of the insertion element (e.g., on a first portion 1805, 1905, 2205) and is configured to physically contact a first bus bar (e.g., 1713) of the spine. The first hole is on the first side of the insertion element and may be configured to receive a first bolt (or screw) that holds the first electrical contact in physical contact to the first bus bar. The second electrical contact is on a second side of the insertion element opposite the first side (e.g., on the second portion 1807, 1907, 2207). The second electrical contact is configured to contact a second bus bar (e.g., 1715) of the spine. The second hole is on the second side of the insertion element and is configured to receive a second bolt (or screw) that holds the second electrical contact in physical contact to the second bus bar.

In some embodiments, a chassis module (e.g., 1800, 1900, 2000, 2200) is configured for installation at any of a plurality of receiving compartments (e.g., 1737) of a spine (e.g., 1700) of a chassis (e.g., 1400). The spine includes two bus bars (e.g., 1713, 1715). The chassis module includes two bus bar contacts (e.g., 1810, 1812) and a port. The bus bar contacts are on a bottom of the chassis module (e.g., at a receiving element 1801, 1901, 2201), where each of the two bus bar contacts physically contact the corresponding bus bar of the spine, and the bus bar contacts and the bus bars have (e.g., standard and/or repeating) hole patterns for attachment of the chassis module to the spine at the receiving compartment. The port is for attachment of a data and/or power connection to the chassis module. The port may be accessible after attachment of the chassis module to the spine (e.g., via holes (e.g., 1735) in wall 1707). In some embodiments (e.g., when the chassis module is a branch module (e.g., 1900)), the chassis module includes attachment points (e.g., stab 1911) for (e.g., eight) branch circuits, where the chassis module distributes electricity from the bus bars to the branch circuits.

### Additional Examples of Panelboards with AFCI Protection

Although previous descriptions provide examples of panelboards with AFIC protection systems and with interface panels, the below paragraphs describe additional examples. The descriptions below may omit features previously described and/or include features that are in addition to or alternative to the features previously described.

In some embodiments, a portion (e.g., a modular electrical component, such as a branch module) of an electrical panelboard (e.g., 102, 1400) includes an interface panel and an arc fault circuit interruption (AFCI) protection system.

The AFCI protection system is configured to detect arc fault events occurring in one or more branch circuits and interrupt the flow of electricity in the one or more branch circuits (e.g., by interrupting the flow of electricity along one or more conductive path located between one or more bus bars of the panelboard (e.g., 115) and one or more branch circuit terminals (e.g., stabs) of the panelboard (e.g., 127).

Example AFCI protection systems are described with reference to FIGS. 1 and 3A-7. For example, the AFCI protection system includes one or more current sensors (e.g., 122, 322), one or more switching devices (e.g., 126, 326), and one or more processing systems (e.g., 124, 324). In these examples, the AFCI protection system may analyze current signals from the current sensors, detect arc fault events based on the analysis, and control the switching devices to interrupt the flow of electricity to the branch circuits in response to detecting arc fault events. As described with reference to FIG. 1, a processing system of the AFCI protection system may be shared by multiple branch circuits.

One or more switching devices (also “interruption switching devices”) of the AFCI protection system may be electrically coupled between (a) one or more bus bars of the electrical panelboard (e.g., 115) and (b) one or more branch circuit terminals (e.g., stabs) of the electrical panelboard (e.g., 127). One or more current sensors may be electrically coupled to one or more conductive paths between points (a) and (b) as well. However, this is not required. As described with reference to FIGS. 3A-C, switching devices and sensors may be elsewhere relative to points (a) and (b).

The interface panel may be physically located on or a physical component of the portion of the electrical panelboard. The interface panel enables a user to interact with the AFCI protection system. For example, the interface panel enables a user to control the AFCI protection system for a branch circuit (or multiple branch circuits). For example, the interface panel enables a user to interrupt the flow of electricity in one or more of the branch circuits, reset an interruption event for one or more of the branch circuits, check the status of one or more branch circuits, check the status of the AFCI protection system, or some combination thereof.

The portion may be a modular electrical component of the electrical panelboard. For example, the portion is a branch module (e.g., 1900) that can slide into one of a plurality of receiving compartments (e.g., 1737) of a spine (e.g., 1700) and couple to the one or more bus bars (e.g., 1729, 1731). For example, the AFCI protection system is contained within receiving element 1901 and the indicator 1913 is replaced with an interface panel (see also FIGS. 12 and 13). To slide into a receiving compartment, the modular electrical component may include a track indentation (e.g., 1909), for example, on an outer surface of the receiving element.

The AFCI protection system may be within an enclosure (e.g., within a receiving element). For example, the AFCI protection system is contained within the receiving element 1901, the enclosure of FIG. 9A, the enclosure of FIG. 10B, or the enclosure of FIG. 11B. The interface panel may be without the enclosure, for example, as illustrated in FIGS. 9A, 10A-B, 11A-B, and 12A-13B. As illustrated in these figures, sections of stabs (examples of branch circuit terminals) may protrude out of the enclosure. In some embodiments, the interface panel is located between the stabs (e.g., see branch modules 900, 1000, 1100, 1200, and 1300. For example, the interface panel is located between two columns of stabs. Traditional overcurrent circuit breakers can receive portions of the stabs exposed from the enclosure. The enclosure may be configured to engage with these traditional overcurrent circuit breakers to hold them in place (e.g., the outer surface (e.g., the top surface) of the enclosure is shaped to engage with the overcurrent circuit breakers). Said differently, the enclosure may be configured such that traditional overcurrent circuit breakers can receive branch circuit terminals and couple to the outer surface of the enclosure (e.g., see 1487 in FIGS. 14B-15).

The interface panel may be on a platform structure raised above the enclosure (e.g., see branch modules 800, 900, 1000, 1100) or on a mesa structure that protrudes away from the enclosure (e.g., see branch modules 1200 and 1300).

The interface panel may include one or more user interactable elements (also “elements”), for example, which face away from the enclosure. Example user interactable elements include a (e.g., mechanical) button (that a user can press), a (e.g., mechanical) switch, and a touch screen. In some embodiments, the interface panel includes sets of interactable elements, where each set corresponds to a different branch circuit (e.g., each switching device of the AFCI protection system). For example, each set enables a user to interact with the AFCI system for a different branch circuit. In a more specific example, each set enables a user to control the AFCI protection system for the corresponding branch circuit. Branch modules 800, 1000, 1100, and 1200 include examples of interface panels with sets of interactable elements for each branch circuit. In other embodiments, the interface panel may include a single set of user interactable elements that can be used to control the AFCI protection system for different branch circuits. For example, the interface panels of branch modules 900 and 1300 each include two buttons and a display (900 includes two displays) that can be used to control AFCI functionalities for multiple (e.g., all) branch circuits of that branch module.

In some embodiments, the interface panel includes a status indicator that visually indicates the status of one or more of the branch circuits. The status indicator may be, for example, a set of light indicators (e.g., LEDs) or a display (e.g., an e-ink display). The status indicator may indicate: that AFCI detection is enabled on a given circuit branch, self-test results, operational data, detection of faults or errors, fault or error type of a detected fault or error, setup information, branch circuit rating, measured values (e.g., voltage or current), fault history, number of faults that have occurred, the need to replace of one or more components (e.g., a switching device, current sensor, or overcurrent circuit breaker) or some combination thereof.

The interface panel may include a reset element (e.g., button or switch) configured to, responsive to activation by the user, reset a functionality of the AFCI protection system responsible for one or more of the branch circuits. For example, responsive to a user activating a reset element, the AFCI system closes a branch circuit that was previously interrupted (e.g., by closing an opened switching device). Additionally, or alternatively, the AFCI system may perform a software reset for that branch circuit.

The interface panel may include a test element (e.g., button or switch) configured to, responsive to activation by the user, test a functionality of the AFCI protection system responsible for one or more of the branch circuits. For example, responsive to a user activating a test element, the AFCI system initiates a self-test of one or more AFCI functions, such as testing different types of arc faults, testing the functionality of the current sensor, testing opening a relay, or some combination thereof.

In some embodiments, an AFCI interface panel include a single interactable element that performs multiple functionalities (e.g., both test and reset functionalities).

In some embodiments, an interface panel includes an interactable element (e.g., with test and/or reset functionalities) that also functions as a status indicator. For example, an interactable button or switch also emits color indicating a status. In a more specific example, an interactable button or switch includes transparent material (e.g., clear plastic) and a light pipe guides light into the button to provide a status indication.

The interface panel may include a means for setting the intended nominal current rating of the AFCI enabled branch circuit (e.g., 15 amps or 20 amps). Example mechanisms for this include a dip switch, rotary dial, or mobile phone application.

Any of the portions of electrical panels with AFCI protection systems (e.g., branch modules) described herein may include additional, fewer, or different components than those illustrated or described. For example, a status indicator (e.g., a light source or displays) or interactable element (e.g., button) may exist on a per-circuit, per-module, or per-panel level. Furthermore, although branch modules are described in separate sections and in different figures, a concept, design, arrangement, etc. for one of the branch modules may also be applied to the other branch modules. Furthermore, descriptions of components relative to a specific branch modules or figure may be applicable to similar components in other branch modules or figures. For example, branch module 800 may include an enclosure (e.g., an injection mold or overmold enclosure). In another example, an AFCI interface component of one of the branch modules, may be applied to any of the remaining branch modules. In another example, branch modules 800 or 900 may include heat sinks similar to those in branch modules 1000 or 1100.

### ADDITIONAL CONSIDERATIONS

Other aspects from the above descriptions and sections include components, devices, systems, improvements, methods, processes, applications, computer readable mediums, and other technologies related to any of the above.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the apparatus disclosed herein without departing from the spirit and scope as defined in the appended claims. Therefore, the scope of the invention should be determined by the appended claims and their legal equivalents.

In the previous descriptions and in the claims, reference to an element in the singular is not intended to mean “one and only one” unless explicitly stated, but rather is meant to mean “one or more.” In addition, it is not necessary for a device to address every problem that is solvable by different embodiments of the invention in order to be encompassed by the claims.

The term “coupling” is not meant to exclude intervening elements. For example, when two elements are described as being coupled to each other, this does not imply that the elements are directly coupled to each other nor does it preclude the use of other elements between the two.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A portion of an electrical panelboard, the portion comprising:
an arc fault circuit interruption (AFCI) protection system configured to detect arc fault events occurring in branch circuits and interrupt the flow of electricity in one or more of the branch circuits, wherein interruption switching devices of the AFCI protection system are electrically coupled between (a) one or more bus bars of the electrical panelboard and (b) branch circuit terminals of the electrical panelboard; and
an interface panel that enables a user to interact with the AFCI protection system.

2. The portion of claim 1, where the interface panel enables the user to control the AFCI protection system for the branch circuits.

3. The portion of claim 1, wherein the AFCI protection system is within an enclosure and the interface panel is without the enclosure.

4. The portion of claim 3, wherein sections of the branch circuit terminals protrude out of the enclosure.

5. The portion of claim 4, wherein the interface panel is between the protruding sections of the branch circuit terminals.

6. The portion of claim 4, wherein the enclosure is configured to engage with overcurrent circuit breakers.

7. The portion of claim 3, wherein the interface panel is on a platform structure raised above the enclosure.

8. The portion of claim 3, wherein the interface panel is on a mesa structure that protrudes away from the enclosure.

9. The portion of claim 3, wherein the interface panel includes one or more user interactable elements facing away from the enclosure.

10. The portion of claim 1, wherein the interface panel includes at least one of:
buttons interactable by the user; or
switches interactable by the user.

11. The portion of claim 1, wherein the interface panel includes sets of interactable elements, and each set corresponds to a different branch circuit.

12. The portion of claim 11, wherein each set of interactable elements enables the user to control the AFCI protection system for the corresponding branch circuit.

13. The portion of claim 1, wherein the interface panel includes:
a status indicator that visually indicates a status of one or more of the branch circuits;
a reset element configured to, responsive to activation by the user, reset a functionality of the AFCI protection system responsible for one or more of the branch circuits; and
a test element configured to, responsive to activation by the user, test a functionality of the AFCI protection system responsible for one or more of the branch circuits.

14. The portion of claim 1, wherein the portion a modular electrical component of the electrical panelboard.

15. The portion of claim 14, wherein the modular electrical component is configured to slide into one of a plurality of receiving compartments of a spine of the electrical panelboard and couple to a bus bar.

16. The portion of claim 15, wherein the modular electrical component includes a track indentation configured to receive a guiding structure of the spine.

17. The portion of claim 16, wherein the track indentation is on an outer surface of the modular electrical component.

18. A modular electrical component of an electrical panelboard, the modular electrical component comprising:
a receiving element configured to slide into one of a plurality of receiving compartments of a spine and electrically couple to bus bars of the spine;
an arc fault circuit interruption (AFCI) protection system at least partially housed in the receiving element, the AFCI protection system configured to detect arc fault events occurring in branch circuits and interrupt the flow of electricity in one or more of the branch circuits, wherein interruption switching devices of the AFCI protection system are electrically coupled between (a) one or more bus bars of the electrical panelboard and (b) branch circuit terminals of the electrical panelboard; and
an interface panel on an exterior of the receiving element, the interface panel enabling a user to interact with the AFCI protection system at least partially housed in the receiving element.

19. The modular electrical component of claim 18, wherein the interface panel includes:
a status indicator that visually indicates a status of one or more of the branch circuits;
a reset element configured to, responsive to activation by the user, reset a functionality of the AFCI protection system responsible for one or more of the branch circuits; and
a test element configured to, responsive to activation by the user, test a functionality of the AFCI protection system responsible for one or more of the branch circuits.

20. The modular electrical component of claim 18, wherein:
the modular electrical component includes a track indentation configured to receive a guiding structure of the spine; and
the track indentation is part of an outer surface of the modular electrical component.
